(19) United States
(12) Patent Application Publication
(10) Pub. No.: US 2008/0082421 A1
(43) Pub. Date: Apr. 3, 2008

(54) Monetization of an advanced contact identification system

(76) Inventors: Richard Onyon, San Jose, CA (US); Liam Stannard, San Jose, CA (US); Leighton Ridgard, San Jose, CA (US)

Correspondence Address: HAVERSTOCK & OWENS LLP, 162 N WOLFE ROAD, SUNNYVALE, CA, 94086, US

(21) Appl. No.: 11/906,586

(22) Filed: Oct. 2, 2007

Related U.S. Application Data
(63) Continuation-in-part of application No. 11/128,121, filed on May 12, 2005.
(60) Provisional application No. 60/827,918, filed on Oct. 3, 2006.
(60) Provisional application No. 60/570,409, filed on May 12, 2004.

(51) Int. Cl. G06Q 30/00

(52) U.S. Cl. 705/14

(57) ABSTRACT

An advanced contact identification system in a wireless communication network is configurable to increase subscribership and revenues for an enterprise service provider and vendors and to increase sales of content. A personal brand having a popular ringtone, graphic or other content may be widely shared among subscribers of the advanced contact identification system. Various configurations of a monetization scheme for subscribers to share popular and incentivized content drive sales for such content and increase revenue.

### RELATED APPLICATION(S)

This application claims priority under 35 U.S.C. § 119(e) of the co-pending, co-owned U.S. Provisional Patent Application Ser. No. 60/827,918, filed Oct. 3, 2006, and entitled “NETWORK AND MOBILE DEVICE SYSTEM FOR MONETIZATION OF AN ADVANCED CONTACT IDENTIFICATION SYSTEM,” and is a continuation-in-part of co-pending U.S. patent application Ser. No. 11/128,121, filed on May 12, 2005 and entitled “ADVANCED CONTACT IDENTIFICATION SYSTEM,” which claims priority under 35 U.S.C. § 119(e) of the co-pending, co-owned U.S. Provisional Patent Application Ser. No. 60/570,409, filed May 12, 2004, and entitled “COMMUNICATION NETWORK IDENTIFICATION SYSTEM,” which are all hereby incorporated by reference.

### FIELD OF INVENTION

The invention relates to a system for allowing users to provide other individuals with a personalized representation of the user in a network environment, such as a cellular telephone network.

### BACKGROUND OF THE INVENTION

Wireless telephones have become more powerful with the inclusion of such features as cameras, address books, calendars and games. Many now include microprocessors, operating systems and memory which allow developers to provide limited applications for the phones. Phones now include the ability to play multimedia files including polyphonic ringtones, MP3 files, MPEG, AVI and QuickTime movies, and the like, in addition to displaying pictures taken on or downloaded to the phone.

Wireless phones have long been able to access the Internet via a Wireless Access Protocol (WAP) browser, and receive messages via Short Message Service (SMS). A user on a wireless telephone connects via the wireless network to a server which enables the phone to read WAP enabled content. Most providers enable a user to access an email message account via the WAP browser, and/or provide SMS messages directly to the user's phone. SMS allows users to receive abbreviated text messaging directly on the phone. Messages can actually be stored on the phone, but the storage available is limited to a very small amount of memory. In addition, no provision for handling attachments in SMS is available.

More recently, phones themselves have become powerful enough to utilize data connections over a carrier's network to manipulate data. For example, users of a carrier's network can download multimedia content to their phone, shop and download phone specific applications, and send and receive more robust messaging. Devices which have been combined with wireless phones, such as Research In Motion's Blackberry device, provide a user with enhanced message capabilities and attachment handling. These devices are specifically configured to provide contact and message applications over a wireless network.

Still, the majority of phones provide limited native address and contact data storage, and only SMS messaging capability. Some phones do allow users to associate images and specific ringtones with users in their phone's address book. Most wireless phones support caller ID, which displays the number of an incoming caller. Using this information, phones having imaging and multiple ringtone capabilities display an incoming caller's address book associated picture (if available) when the incoming call is received, and play a specially designated ringtone (if specified).

With the numerous different types of wireless phones and other communications devices available, a system which will enable users to provide a personalized representation of themselves on other users' phones would be useful in allowing the users to identify themselves to other users.

### SUMMARY OF THE INVENTION

The present invention, roughly described, pertains to a system and method which allows advanced contact identification information to be created and distributed to users of wireless communication devices, such as mobile phones. Subscribers can define their own personas as collections of information which define the users. Subscribers can then publish their persona(s) to their friends' and associates' mobile phones, and update the others' address books with the subscriber's contact information. Users can specify different personas to be presented to different users.

In one embodiment, the invention is a system for providing personification information to users of a wireless phone.

In another embodiment, the invention is a method of identifying a service subscriber on a wireless device. The method may include the steps of: establishing a subscriber persona comprising information identifying a user to other users; and displaying at least a portion of the persona on a device when a call or other type of contact such as SMS, Push-To-Talk message, email, voiceclip, is received from another subscriber whose personalization information has been provided to the user.

In another embodiment, the invention is a method of providing an advanced caller identification service. In this embodiment, the invention includes: maintaining a store of subscriber persona information provided by users, the persona information identifying the user to other users, and distributing persona information to others based on an established relationship between subscribers.

A still further embodiment of the invention includes an application on a subscriber phone. The application includes a store of personification information for at least one other subscriber, and a display interface providing personification information to a phone interface and an interface for managing the user's own personalization information, as well as any system or account preferences.

In another embodiment, the invention is an application server for a communication system. The sever includes a store of personification information for a plurality of subscribers and a distribution system management application.

In another aspect, a method of monetizing a contact identification system comprises establishing a contact session in a network with a recipient. Typically, the contact session is a call, an SMS message, an MMS message, an email, a voice clip, and a reminder. The method further comprises presenting a media on a device used by the recipient. Typically, the media is a ringtone, an image, a video clip, a song, a music clip, an aroma, a physical sensation, or a combination thereof. The media is generated by an advertiser, a subscriber, or a vendor. The method further comprises offering an at least one incentive by an at least one entity. Preferably, the network is accessible by the at least one entity. Typically, the at least one incentive is offered upon the recipient using, purchasing, acquiring, or otherwise interacting with the media in a predetermined manner and is offered to at least one of a caller and the recipient. The at least one incentive is credits, money, media, a voucher, a coupon, an entry in a drawing or contest, an item of value, or any other valuable consideration, or a combination thereof. The method further comprises presenting the recipient with a plurality of options on the device. The plurality of options include acquiring, giving an opinion of, adding, learning more about and blocking the media. The method further comprises storing information on a server. Typically, the information includes the media and associated actions by the recipient. The method further comprises synching the device with the server.

In another aspect, a monetization method for a contact identification system comprises making available a media for distribution in a network. Typically, the media is a ringtone, an image, a video clip, a song, a music clip, an aroma, a physical sensation, or a combination thereof. The media is generated by an advertiser, a subscriber, or a vendor. The method further comprises establishing a contact session in the network with a mobile device. Preferably, the contact session is configured to present the media on the mobile device. In some embodiments, the contact session is human-initiated. In other embodiments, the contact session is automatically-initiated. The method further comprises presenting a plurality of options for a user of the mobile device. Typically, the plurality of options include acquiring, giving an opinion of, adding, learning more about and blocking the media. The method further comprises awarding an at least one incentive by or to an at least one entity with access to the network. Preferably, the at least one incentive awarded upon the recipient using, purchasing, acquiring, passing-along to or making available to other subscribers or non-subscribers, or interacting with the media in a predetermined manner. The method further comprises storing information in a storage. Typically, the information includes the media and associated actions by the recipient. Preferably, the storage is a network server or a database.

In yet another aspect, a system for monetization comprises a device configured for accepting a contact session in a network. Preferably, the device is used by a recipient. In some embodiments, the contact session is human-initiated. In other embodiments, the contact session is automatically-initiated. The system also comprises a media configured to render on the device. Typically, the media is a ringtone, an image, a video clip, or a combination thereof. The system also comprises at least one entity with access to the network offering at least one incentive. Typically, the at least one incentive is offered upon the recipient using, distributing, or interacting with the media in a predetermined manner. The system also comprises a plurality of options on the device presented to the recipient. Typically, the plurality of options include acquiring, giving an opinion of, adding, learning more about and blocking the media. The system also comprises at least one participant. Typically, the at least one participant generates the media. The at least one participant is an advertiser, a subscriber, or a vendor. The system further comprises a server configured to store information. Typically, information includes the media (and/or information about the media), and associated actions by the recipient.

The present invention can be accomplished using hardware, software, or a combination of both hardware and software. The software used for the present invention is stored on one or more processor readable storage media including hard disk drives, CD-ROMs, DVDs, optical disks, floppy disks, tape drives, RAM, ROM or other suitable storage devices. In alternative embodiments, some or all of the software can be replaced by dedicated hardware including custom integrated circuits, gate arrays, FPGAs, PLDs, and special purpose computers. These and other objects and advantages of the present invention will appear more clearly from the following description in which the preferred embodiment of the invention has been set forth in conjunction with the drawings.

### BRIEF DESCRIPTION OF THE DRAWINGS

FIG. 1 is a flow chart illustrating a method in accordance with the present invention.

FIG. 2 is a flow chart illustrating a second method in accordance with the present invention.

FIG. 3 is a block diagram of a system suitable for implementing the identification system of present invention.

FIG. 4 is a flow chart illustrating a first method for providing an invitation to a non-subscriber to join a service established by an enterprise service provider in accordance with the present invention.

FIG. 5 illustrates a second method for providing an invitation to a non-subscriber in accordance with the present invention.

FIG. 6 is an illustration of personas and persona groups relative to a subscriber in accordance with the present invention.

FIG. 7 is an illustration of the structure of a system database store on a server in accordance with the present invention.

FIG. 8 is a sequence diagram illustrating the actions which occur on a client device, server, and server interface to allow a new user to subscribe to the advanced contact identification service in accordance with the present invention from a phone.

FIG. 9 is a sequence diagram illustrating how a user account is created when the system is used with a synchronization server in accordance with U.S. Pat. No. 6,671,757.

FIG. 10 is a sequence diagram illustrating how a new subscriber is established on a server provided interface in accordance with the present invention.

FIG. 11 is a sequence diagram illustrating how a user already having an account with the system, but utilizing a new phone, would interact with a server in accordance with the present invention.

FIG. 12 use case diagram illustrating the functions available to a user/subscriber in accordance with the system of the present invention.

FIG. 13 is a use case diagram illustrating the contact management available to a user/subscriber in accordance with the system of the present invention.

FIG. 14 is a use case diagram illustrating the persona control functions available to a user/subscriber in accordance with the system of the present invention.

FIG. 15 is a use case diagram illustrating the multimedia control functions available to a user/subscriber in accordance with the system of the present invention.

FIG. 16 is an exemplary advanced ID screen provided on a phone in accordance with the present invention.

FIG. 17 is an exemplary advanced ID screen with metadata provided on a phone in accordance with the present invention.

FIG. 18 is an exemplary advanced ID screen with control functions provided on a phone in accordance with the present invention.

FIG. 19 is an exemplary user interface home screen for a user managing an advanced contact ID system in via a web browser in accordance with the present invention.

FIG. 20A is an exemplary user interface for managing contacts via a web browser provided by a server in accordance with the present invention.

FIGS. 20B-20M are exemplary user interface screens provided on a client device such as a phone to manage contacts providing the features shown with respect to FIG. 20A on a client device such as a phone.

FIG. 21A is an exemplary user interface for managing personification information provided by a server on a web server in accordance with the present invention.

FIGS. 21B-21N are user interface screens which may be provided on a client device such as a cell phone to implement the features shown in FIG. 21A.

FIG. 22 is an exemplary user interface screen provided on a server allowing a user to manage images in accordance with the system of the present invention.

FIG. 23 is an exemplary user interface provided by a server in a web browser allowing a user to manage multimedia in accordance with the system of the present invention.

FIG. 24 is an exemplary user interface provided in a web browser by a server in accordance with the present invention allowing a user to manage details of the user's account in accordance with the system of the present invention.

FIG. 25 is an alternative client server configuration utilizing the synchronization system disclosed in U.S. Pat. No. 6,671,757 to implement the system of the present invention.

FIG. 26 is a depiction of the system of FIG. 25 integrated with multiple participants and subscribers in accordance with the system of the present invention.

FIG. 27 is an exemplary client application structure suitable for use in accordance with the present invention.

FIG. 28 is a static structure illustrating the information contained in a client-side database in accordance with the present invention.

FIG. 29 is a static structure of an entity manager utilized on a client structure such as that shown in FIG. 28.

FIG. 30 is an exemplary alternative configuration of a client application in accordance with the present invention.

FIG. 31 is another alternative client configuration in accordance with the present invention.

FIG. 32 is yet another alternative client configuration in accordance with the present invention.

FIG. 33 is yet another alternative client configuration in accordance with the present invention.

FIG. 34 is yet another alternative client configuration in accordance with the present invention.

FIG. 35 is a structure illustrating the functions of the client side media manager in accordance with the present invention.

FIG. 36 is an exemplary advanced ID screen provided on a phone in accordance with a monetization embodiment of the present invention.

FIGS. 37-38 are exemplary user interfaces provided by a phone in accordance with a monetization embodiment of the present invention.

FIG. 39 is an exemplary advanced ID screen provided on a phone in accordance with a further monetization embodiment of the present invention.

FIG. 40 is a flow chart illustrating a monetization process of the present invention.

FIG. 41 is a flow chart illustrating another monetization process of the present invention.

### DETAILED DESCRIPTION OF THE PREFERRED EMBODIMENT

The present invention allows advanced contact identification features to be provided to a phone or other mobile device by allowing a user to provide personification information for other users of advanced wireless communication devices. Each user can create one or more individualized representations of themselves and push this information to other users. The service is generally enabled by an enterprise service provider or cellular network carrier via one or more servers. Users can subscribe to the service, allowing them to create and distribute sub-sets of personification information or “personas”, or merely participate in an advanced contact identification system, receiving personification information from subscribers. Since devices have different capabilities, the system will vary in its ability to provide personification information to each device, and in one embodiment, the type of user device and its capabilities are stored for each member of the system. The method and implementing systems and applications of the present invention provided by an enterprise service provider (ESP) may be subject to a service fee to maintain the personification information in a data store, and provide functionality associated with the system.

In general, a new subscriber creates a personification of the new subscriber which may include the new subscriber's contact information, signature, photo, multimedia information and a specific ringtone identifying the new subscriber to other phone users. Many cellular phones include an ability to download specific ringtones and use the ringtones to identify incoming callers by associating a ringtone and picture with a contact information in the phone and triggering it using caller ID functions. The system of the present invention allows the new subscriber to specify the subscriber's own ringtone and picture, and use it to identify the new subscriber to other users. In addition to the static information in the personification information, the new subscriber may provide dynamic information such as GPS location, time zone, availability, and event-relevant information (e.g., a reminder it's a caller's birthday, or a summary of calendar events, blogs, reminders, or tasks assigned to or by the caller) or control information to other users or participants.

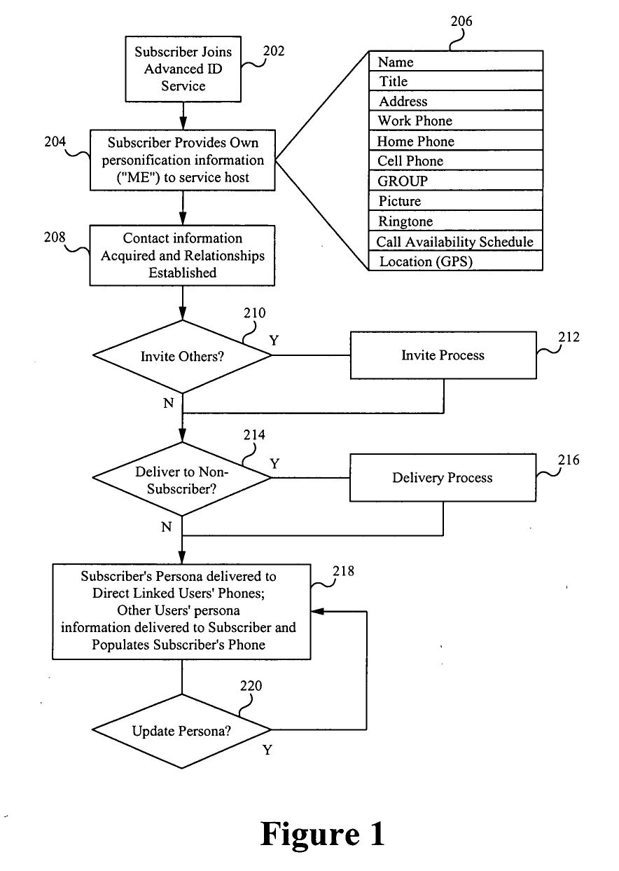

FIG. 1 illustrates a general method in accordance with the present invention. At step 202, the new subscriber joins an advanced contact ID service. The new subscriber establishes an account by providing account creation information such as a user name, a secure password, and other configuration information. This step may be performed via a phone based interface or via a web based interface or any other suitable interface means.

At step 204, the new subscriber may set the subscriber's own personification information. This is referred to in Figures occasionally as creating or updating “me”. As shown at table 206, the new subscriber's personification information may include the new subscriber's name, address, phone number and any other contact information, a picture of the new subscriber, a specific ringtone for the new subscriber, and a schedule of available times that the new subscriber may be contacted in various manners. In addition, the new subscriber may input user location information. Location information may be of varying specificity, and may initially input manually or through a connection with a GPS system in a GPS enabled phone. Information in the location section of the new subscriber's system may be updated by an agent on the phone using the phone's GPS agent. The ringtone may be uploaded by the new subscriber or may be selected from tones provided by a system administrator as part of the service, or the new subscriber may use the phone's microphone (if equipped) to author a new audio clip which will be used as a ringtone. Optionally, a value added media distributor may provide phones, and digital rights management incorporated in the system to ensure proper control of copyrighted material within the system of the present invention. A phone manufacturer, a mobile phone carrier, or another entity may add DRM functionality as well, which may determine which protected content may be redistributed (and how). It should be recognized that step 204 is optional, and the new subscriber may decide not to provide personification information, but only participate in the system to acquire personification information of others. In another embodiment, subscription to the advanced contact ID service provided by the ESP is not required to receive personification information.

As discussed in further detail below, different sets of personification information (or “personas”) may be provided for different groups of individuals in the new subscriber's contact list. For example, the new subscriber may wish one group of contacts to receive one set of personification information (such as business contacts), while another set (such as personal friends) to receive a different set of information. A group definition allows the new subscriber to define recipients who receive a particular version of contact information. The new subscriber may assign one or more users to a particular group using an interface provided on the phone, or alternatively via some other interface, such as a webpage or an administrative configuration console. Additionally, the new subscriber can specify a “public” persona which anyone may download (and will be automatically assigned to new contacts in the new subscriber's phone). The system or agent maintains group assignments in persistent storage. The system or agent transmits the information appropriate for each group to the members of the group using the above described techniques. The enterprise service provider can allow the new subscriber to have a default persona upon establishing an account with the system. For example, the system can establish default, public friends, family, co-workers, business associates, and blacklist persona templates, allowing the new subscriber to input certain information and have established personas once the new subscriber joins the system. The blacklisted persona is intended to be assigned to buddies to whom the new subscriber does not want to publish information.

At step 208, the new subscriber's contact records are provided to the ESP in one of a number of ways, and relationships are detected between the new subscriber's contact records and other subscribers'. This input may be as simple as downloading phone numbers that the new subscriber has stored in the new subscriber's phone, or may include additional contact information which allows the system to determine whether individuals are members of the system. In addition, the new subscriber may manually input contacts during account creation, or download contact information from another source, such as a personal information manager on a personal computer or personal digital assistant. A search mechanism may also be provided, allowing the new subscriber to input information on individuals to determine whether an individual is part of the system. For example, if the new subscriber does not have a stored resource of personal information, the new subscriber may, via the web browser, access a form provided by a system administration which provides name and other contact fields which the system can use to search for other users participating in the system. Once found, this information can then be provided to the new subscriber.

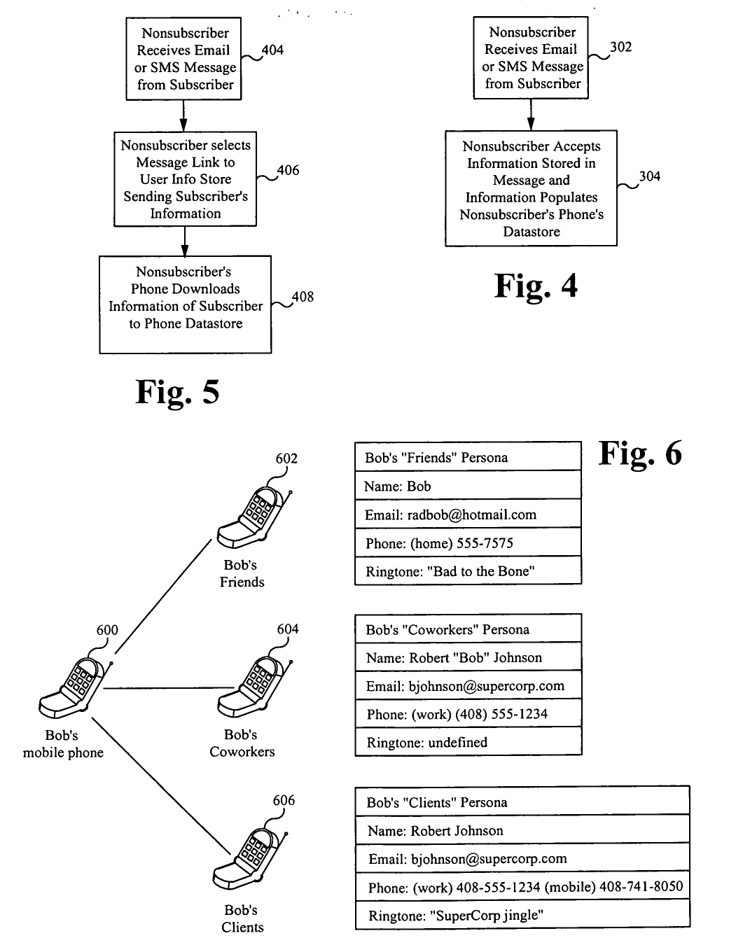

In accordance with the system of the present invention, different types of links may be established between users. Generally, a user's contact list is found in a user address book in a phone data store. Due to the nature of human communication, it is likely that a contact in the user's address book will have the user's information in that contact's own address book. For example, assuming Bob and Alice are both friends, they will likely have each other's contact information in their respective address books. This reciprocal link between people can be utilized to recognize and distinguish different types of links. In accordance with the invention, “half” linked users are users who have other's contact information in their address books, but the others do not reciprocate. Unlinked users are not connected for purposes of data exchange and the invitation functions provided in FIGS. 4 and 5 may be offered to unlinked users giving them the opportunity to subscribe to the system and establish true links with an inviter. “True” or “direct” linked users exist when both users have each other's contact information in their respective address books. These users have established some level of relationship outside of the service provided by the enterprise service provider or via system's “Invitation” function, and will automatically exchange and maintain any information each user has configured. Within a context of the foregoing description a “buddy” is any user who has established a true link with an individual user. For privacy as well as practicality, information exchange in the system occurs only between true linked users. Half-linked users may invite the unlinked user to join the system to establish true links. Additionally, in another embodiment, half-linked users are able to receive information pushed by other users without requiring the establishment of a true link. In such circumstances, the system is used as a distribution mechanism for details to or from users without requiring reciprocal address book relationships

As discussed above, when the new subscriber provides his own personification information to a service host at step 204, links between users are detected at step 208 by examining the contents of their address books which are provided to an advanced ID service server. At step 208, once the contacts have been acquired, relationships between the new subscriber's contacts and other subscribers are established. This can occur automatically by an algorithm run by the ESP, may be set manually by the new subscriber, or may occur by some combination of the two.

In order to identify each user from a pool of all users of the system, the system uses telephone numbers and in one embodiment e-mail addresses as unique keys. In a further embodiment, the system of the present invention can use telephone number equivalence algorithms to match phone numbers regardless of formatting, country and area codes.

Users who wish to remove their information and “unlink another user” simply remove that user from their phones' address books. Using rules of the system, two users are no longer linked and no further updated information between them occurs. No information is deleted from a unlinked party's address book in this process. Another approach is to assign the unlinked party to a “blacklisted” persona.

Optionally, at step 210, the new subscriber may be offered the opportunity to invite other people to become subscribers. The new subscriber may be prompted to determine if the new subscriber wishes to invite contacts stored in the new subscriber's phone to become subscribers to obtain additional benefits attributable to subscription. If the new subscriber wishes to invite others, an invite process is performed at step 212.

Optionally, at step 214, the new subscriber may be given the option to allow the new subscriber's persona to be provided to non-subscribers. If the new subscriber desires the personification information to be delivered, a delivery process 216 transmits the personification information to non-subscribers. This may occur in any number of ways, such as via SyncML or via SMS messages, as described below.

At step 218, personification information from other subscribers in the new subscriber's contact list is delivered to the new subscriber, and the new subscriber's information is sent to the other subscribers. As discussed below, contacts who are also subscribers are true-linked users and automatically populate the new subscriber's phone. The information may be transmitted to the new subscriber in a data stream directly to the agent, which then populates the new subscriber's phone data. Alternatively, the information may be provided in a series of messages. Preferentially, the information will be transmitted via SyncML.

Included in persona information is whether the new subscriber's contacts should be alerted the new subscriber's location based on the GPS system in the GPS enabled phone or manually entered location information in the new subscriber's own record. Also included may be, for example, the level of granularity available to the new subscriber's contacts. For example, a receiving member may be allowed to know the country, city or a more or less specific location. Once received, the receiving member may further configure the new subscriber's personification information based on the information received. For example, suppose the new subscriber provides location information in the new subscriber's record. The receiving member may specify that the receiving member wishes to be notified when the new subscriber with location information moves to a particular location or within a particular distance from the receiving member.

Other criteria may also be configured, such as group information. For example, the new subscriber may specify which groups each contact belongs to so that if a requesting member requests personification information about the new subscriber, the correct group information is provided to the requesting member.

Finally, at step 220, the new subscriber may update information in the new subscriber's persona. When the new subscriber does so, the information is re-transmitted to true linked subscribers and, if enabled, non-subscribers in the system. Updates may be started on the new subscriber's device by a client application as a result of data changes on the device. This may occur because of user interaction with the device, or changing transient information such as time zone. Updates can occur in one of two ways. Server-initiated updates are triggered by time intervals, or a change in data which is to be sent to the new subscriber's device. Server-initiated updates are handled via direct socket connection to the client or via SMS messages or some other asynchronous notification mechanism sent from the advanced ID service server to the client application on the device. Each advanced contact ID account supports a configurable “server initiated sync on/off” setting which controls whether SMS messages are automatically sent when a client is out of date. The SMS message from the advanced ID service server may be sent to the text port (or configured data port, if appropriate).

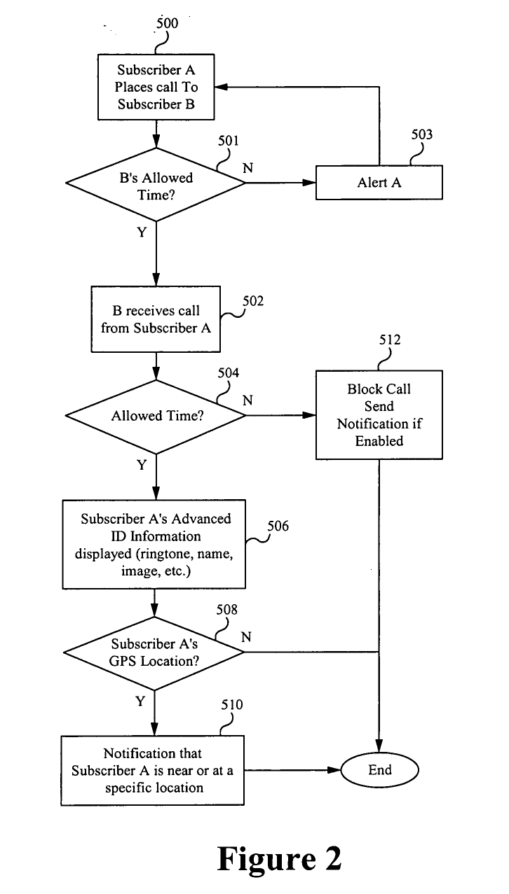

FIG. 2 shows the method of the present invention once the new subscriber has established a relationship with the enterprise service provider in accordance with the present invention and installed the client application on the new subscriber's phone. At step 500, when a receiving user, Subscriber B, receives a call from calling user, Subscriber A, who has downloaded Subscriber B's information into Subscriber A's phone, advanced caller identification features can provide Subscriber A's information at step 506 on Subscriber B's phone.

In one aspect, the system supports controlling both the calling user's phone and the receiving user's phone. At step 501, if Subscriber B has configured Subscriber B's persona (which is downloaded to Subscriber A) to prevent calls during a certain period of time, the client application 140 on the calling user's phone can prevent Subscriber A from connecting to Subscriber B during this period. Hence at step 501, the method may check (on Subscriber A's phone) whether a call to Subscriber B is allowed based on Subscriber B's configuration. If not, an alert 503 may be provided to Subscriber A.

At step 502, if the call is initiated by Subscriber A and received by Subscriber B, optionally at step 504, the receiving user can configure the receiving user's phone to prevent calls during a specific period of time. Hence, at step 504, the method may check to determine whether a call is allowed during a specific period by the receiving user. If the call is not allowed, the method may block the call at step 512. If the call is not blocked, the calling user's advanced contact ID information (persona) is displayed on the receiving caller's phone at step 506, as mentioned above. If the call is blocked, it may be directed to the receiving user's voicemail system. In another embodiment, the call-initiating party whose call is blocked may be directed to use another form of communication such as SMS, email, IM, or voice clip.

An advanced contact ID information or persona is a collection of information which defines a particular user, such as a phone number, e-mail address, picture, geo location information and other data. This allows subscribers to manage their own “personal brand,” controlling how they are represented on other users' phones by specifying ringtones or pictures associated with their contacts. As discussed herein, one can have a “friends” persona and a “co-workers” persona which contain different information or different sets of information. Additional features such as geo location information provided by GPS enabled phones is also provided, as is information about the caller which is transient in nature—such as whether it's the caller's birthday or anniversary, or information concerning phone calls, meetings, or tasks assigned to or by the caller.

The system may be implemented by using a direct push system from an advanced ID service server via a SyncML server to a SyncML client, or may be operated on by a specific client application resident in the phone which communicates with the service-side implementation. SyncML is an Extensible Markup Language (XML) protocol under development as an open standard for the universal synchronization of data between devices. Synchronization of data allows changes made to data on one device (such as a smartphone or a laptop computer) to be instantly reflected in data on another device (such as a networked computer).

Optionally, at step 508, if the calling user has chosen to provide the calling user's GPS information, at step 510 the GPS can be provided in a notification to show that the calling user is at or near a specific location.

The present invention supports two different types of data: static and dynamic. Static data can include a user's ringtone, name and image. The static information is provided by the calling user to the receiving user's client application on the receiving user's phone at step 506. Step 501 indicates a feature of the present invention which allows the calling user to define the calling user's own personification information to control the receiving user's phone—this dynamic or “active control” information can be updated more often than the static persona information. Dynamic information such as GPS or time zone information is updated regularly based on the needs of the calling user. Due to the interaction of the client application on the receiving user's phone, the receiving user may actually prevent (or merely warn) the calling user from calling the receiving user's phone and may instead provide the calling user a user-configurable message which may direct the calling user to use some other mechanism to contact the intended receiving user (e.g., SMS, email, etc). As with all other similar information, this preferred availability information is stored users' personas.

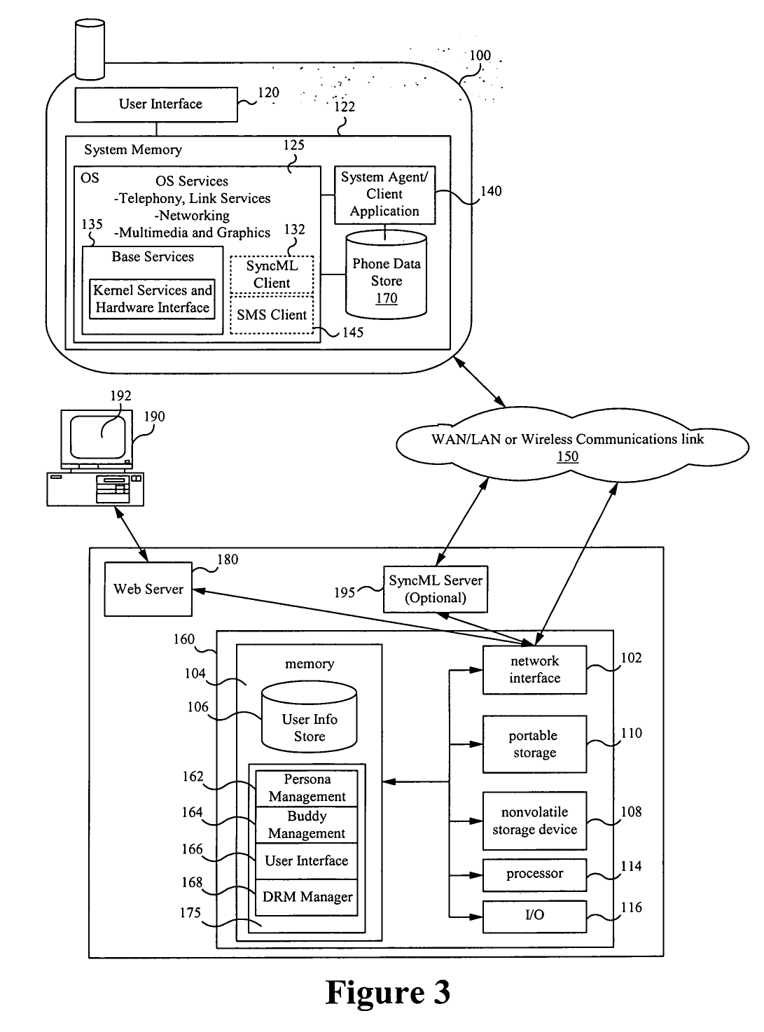

FIG. 3 illustrates a general overview of a system for implementing the present invention. As shown in FIG. 3, a wireless communication device, such as a phone 100, is connected to a wireless communications link or network 150 to transmit voice and data communications to other devices coupling to the wireless communications link 150. It will be understood that the wireless communications link 150 may be a wireless internet link or a cellular network maintained by a cellular carrier, a GSM or CDMA network, or some other wireless communications link. The carrier may comprise the enterprise service provider or may be separate from the enterprise service provider. Data may be transmitted over the network in any number of known formats.

An advanced ID service server 160 is also provided which communicates with the phone 100 via the wireless network 150 directly over a data connection or via a SyncML server 195. Various embodiments of the system for implementing the advanced contact ID service are discussed herein. In FIG. 3, the advanced ID service server 160 communicates directly with the phone 100. In alternative embodiments, discussed below, the advanced contact ID system is implemented using a synchronization server such as that described in U.S. Pat. Nos. 6,671,757, 6,694,336 or 6,757,696.

The phone 100 may be provided with a system application or agent 140. The system agent 140 can include a SyncML communication client designed to interact with the SyncML server 195 in accordance with approved and proposed versions of the SyncML OMA DS specification, including proposed extensions (available at http://www.openmobilealliance.org). Alternatively, the system agent 140 can be an application designed to communicate with the advanced ID service server 160 using an existing SyncML client 132 on the phone 100 provided by the phone's manufacturer (as well as any custom extensions supported by such SyncML client 132), or an application specifically designed to communicate with the advanced ID service server 160 via another protocol, including a proprietary protocol. In one embodiment, the system agent 140 has a fully implemented SyncML communication client and the advanced ID service server 160 includes a SyncML server 195. In another embodiment, the application is a client application device sync agent such as that disclosed in U.S. Pat. No. 6,671,757. Various embodiments of the client application 140 are set forth below.

In accordance with the present invention, the phone 100 includes a system memory 122 which may further include an operating system (OS) 125 having operating system services including telephony and linking services, networking services, multimedia and graphics display services all provided to a user interface (UI) 120. The OS 125 may be the phone's proprietary OS, BREW, or any other device or operating system suitable for a phone (such as the Symbian Operating system). Additional base services 135 and operating system kernel services may also be provided. The operating system 125 may additionally provide an SMS client 145 built into the operating system 125 allowing short messages to be provided across the wireless communications link 150 to other users. Still further, the SyncML client 132 may be provided and supported by the operating system services. The phone 100 includes a native phone data store 170 which contains an address book of contacts and other information which may be provided by a subscriber. Such information can further include ringtones, pictures, sounds, and movies, all dependent on the functional capabilities of the phone 100, the space allowed in the system memory 122, and the services provided by the operating system 125.

The client application 140, various embodiments of which are discussed herein, is also loaded into phone 100. As will be well understood by one of average skill in the art, the client application 140 can be provided by the phone manufacturer or downloaded by a user at a later time. To download and install the client application 140, the user selects a download area of the phone operating system 125, selects the client application 140 from offerings provided by the service provider or carrier who maintains the wireless communications link 150, or an enterprise service provider who maintains the advanced ID service server 160, and installs the client application 140 onto the phone 100. In an alternative embodiment, the system agent 140 is a self-supporting application designed to run as a JAVA or BREW agent, or any other device or operating system specific agent (such as an agent operable on the Symbian Operating system). This system agent 140 can either include its own SyncML communication client, or interact with the existing SyncML client 132 on the phone 100. Changes can occur at field level or byte level. Alternative embodiments can communicate via alternative protocols via the wireless communications link 150 to store information in the user info store 106.

The phone 100 includes at least the user interface (UI) 120, the client application 140 having a communication or sync engine and data store manager, the SyncML client 132 and the phone data store 170. The client application 140 provides an appropriate graphical user interface to the UI 120 which provides the user an alternative point of interaction with the system and service provided by the enterprise service provider. The graphical user interface allows the user to define and manage personas and buddies as well as other tasks as specified in the case definition described herein. Interaction with the system can be via this phone user interface 120 or via an interface provided by the web server 180. The sync engine and data store manager are responsible for maintaining user settings and options in the phone's persistent storage as well as automatically pushing and retrieving changes to and from the advanced ID service server 160. The phone data store 170 includes account information, persona data, buddy information, data for other users who have true links with the subscriber, and multimedia content

The advanced ID service server 160 is a centralized storage location for all system service information, including buddy, persona, relationship, and user data. The client application 140 can connect to and synchronize with the advanced ID service server 160 to update a local copy of this data as well as publish any changed information or retrieve any new available information from the advanced ID service server 160. In the phone 100, the persona information belonging to the user's buddy is primarily stored in the native address book or a separate address book provided by the client application 140. As some devices will not support all the published buddy information including the extended information such as geo location and presence information, the client application 140 can store this information in a phone data store 170 and provide access to it via the phone user interface 120.

In general, a hardware structure suitable for implementing the advance ID service server 160, the web server 180 or the SyncML server 195 includes a processor 114, memory 104, nonvolatile storage device 108, portable storage device 110, network interface 102 and I/O device(s) 116. The choice of processor 114 is not critical as long as a suitable processor with sufficient speed is chosen. Memory 104 could be any conventional computer memory known in the art. Nonvolatile storage device 108 could include a hard drive, CDROM, CDRW, flash memory card, or any other nonvolatile storage device. Portable storage 110 could include a floppy disk drive or another portable storage device. The advanced ID service server 160 may include one or more network interfaces 102. An example of a network interface includes a network card connected to an Ethernet or other type of LAN. I/O device(s) 116 can include one or more of the following: keyboard, mouse, monitor, display, printer, modem, etc. Software used to perform the methods of the present invention are likely to be stored in nonvolatile storage device 108, volatile memory 104 and portable storage media 110.

The advanced ID service server 160 also includes the user info store 106. In alternative embodiments, the user info store 106 is stored in memory 104, non-volatile storage 108, portable storage 110 or another storage device that is part of the system of FIG. 3 or is in communication with the system of FIG. 3. Other alternative architectures can also be used that are different from that depicted in FIG. 3. Various embodiments, versions and modifications of systems of FIG. 3 can be used to implement a computing device that performs all or part of the present invention. Examples of suitable computing devices include a personal computer, computer workstation, mainframe computer, handheld computer, personal digital assistant, pager, cellular telephone, smart appliance or multiple computers, a storage area network, a server farm, or any other suitable computing device. There may be n number of servers 160, n+1 managed by a system administrator providing a back up service in accordance with the present invention.

While only one user info store 106 is shown, it should be recognized that the user info store 106 may be replicated to or stored over a plurality of computers to ensure that the data thereon is protected from accidental loss. It should be understood that the representation of the SyncML server 195 and web sever 180 need not require that such servers be provided on different physical hardware than the advanced ID service server 160.

The system of FIG. 3 illustrates one advanced ID service server 160 and one device 100 system suitable for use in the present invention. In an alternative embodiment of the invention, the advanced contact ID system can be constructed using a synchronization server described in U.S. Pat. Nos. 6,671,757, 6,694,336 or 6,757,696.

A synchronization system described with respect to U.S. Pat. Nos. 6,671,757, 6,694,336 or 6,757,696 comprises client software which provides the functions of a differencing transmitter/receiver/engine, and differencing synchronizer in the form of a device engine. The device engine may include at least one component particular to the type of device on which the device engine runs, which enables extraction of information from the device and conversion of the information to difference information, and transmission of the difference information to the storage server. The storage servers utilized in the system may be any type of storage server, such as an Internet server or an FTP server, and may be provided from any source, such as any Internet service provider. In a key aspect of the sync system, the Internet connection between the devices or between the devices and a server, need not exist at the same point in time. In addition, only those changes to the information which are required to be forwarded to other systems on the system of the present invention are transmitted to enable fast response times.

Data from each of the sync client devices is coupled with a storage server. In one embodiment, each device engine implements all processing required to keep all the systems fully synchronized. Only one device engine needs to be coupled to the sync server at one particular point in time. This permits synchronization of multiple systems in a disconnected fashion. Each device engine will download all transactions encapsulating changes that have occurred since the last synchronization from the server and apply them to the particular device. The change or difference information (termed a “data package” or “change log”) is provided in one or more data packages. Each data package describes changes to any and all transfer information across all device engines, including but not limited to application data, files, folders, application settings, and the like. Each device engine can control the download of data packages that include classes of information that apply to the specified local device. For example, contact names and phone numbers while another needs only changes to e-mail, changes to document files.

Compression and encryption of the data packages may be optionally provided. Each device engine performs mapping and translation steps necessary for applying the data packages to the local format required for that type of information in the application data stores. The device engine also includes components which allow it to track ambiguous updates in cases where users have changed data to a particular data field on two different systems simultaneously since the last update. The output of the device engine comprises a data package which is output to sync server database. As noted above, only one device engine need be connected to the storage server at a given time. The data package can be stored on the storage server until a request is made to a particular location of the storage server by another device engine. Access to areas of the storage server is controlled by a management server (MS). In one embodiment, each sync operation requires that the device engine for each device login to the management server to authenticate the device and provide the device engine with the location of the individual device's data packages on the storage server.

When data is returned to the delta module from the storage server, the delta module returns differenced data to the application object for the particular application which then translates the delta information into the particular interface utilized for application. Once a device engine has been fully applied all data packages from an input stream, it generates a series of data packages that describe the changes made on the local system. The device engine uses the local application object to keep track of the last synchronized version of each application's actual data, which is then used for the next data comparison by the delta module on the next sync request. Generated data packages can include operations and encode changes generated from resolving ambiguous cases as described above.

The sync server uses the concept of a universal data record in its internal sync differencing engine and when sending data to and retrieving from external entities.

The management server supports an authentication interface that requires each device engine to authenticate with the management server before performing synchronization. Certain storage server implementations may utilize locking semantics to control read and write access to storage for multiple device engines. For example, in a generic FTP request, if two device engines attempt to connect to the same data at the same time, there must be some form of locking control to prevent device engines accessing the same data at the same time. In this instance, the management server controls the device engine acquisition, renewal, and releasing of locks against data stored in the network.

Each device engine is uniquely identified and tracked by the management server. This allows for tailoring behavior between the management server and specific types of storage systems and device engine components. All device engine components are tagged and version stamped for management via the management server.

Also shown in FIG. 3 is a server-side application ID service controller application 175 which includes a persona management component 162, a buddy management component 164, a user interface 166, and a digital rights manager 168. It will be understood in various implementations of the present invention that these functional components operating within the server-side application 175 can push information maintained by the system of the present invention directly into the phone 100 via the SyncML server 195 interacting with a fully robust SyncML client. Optionally, certain aspects of the control are handled by either the server-side application 175 or the client application 140, as described herein.

In accordance with the invention, the client application 140 communicates personification information and changes made to the personification information stored in the phone data store 170 to the advanced ID service server 160 via the wireless network 150. Communication of user data from the phone 100 may take several forms. Where the client application 140 utilizes the SyncML client 132 with the advanced ID service server 160, communication may take place using the standards set forth in the SyncML specification. Changes are transmitted on a record-by-record basis or field-by-field basis. Alternatively, communication may occur via another protocol. The SyncML client 132 is utilized to update the phone's 100 native address book with buddy published information as well as to retrieve persona and link information from the advanced ID service server 160. Information can be exchanged via the SyncML protocol, or via a direct data link with the advanced ID service server 160. The advanced ID service server 160 stores and maintains each user account, link personal and buddy information as well as multimedia content, both system provided and user created. The advanced ID service server 160 is a stand alone server and may be incorporated with the features of a synchronization system such as that described in U.S. Pat. No. 6,671,757. Details of this integration are described in further detail below. As noted above, a management interface is provided via the web server 180. Description of this interface is shown below.

The advanced ID service server 160 stores user data in the user info store 106 in a manner which associates the data with an individual user of the phone. In one embodiment, the data is stored in bulk—that is all records and information for the individual user are stored in simple text form, (or binary form, depending on the type of data in use). This information is stored in the data store using a unique identifier (UID) associating the personification data with the individual user. The identifier may be any randomly selected identifier, so long as the individual user is uniquely identified, and the data is associated with the user. In a further aspect, this user UID may be a universally unique identifier (UUID), created in a manner described in the aforementioned U.S. Pat. Nos. 6,671,757, 6,694,336 or 6,757,696 or other manners to create a single ID for a given user. In yet another embodiment, user data and changes to the user data are stored in change logs in a manner described in the aforementioned U.S. Pat. Nos. 6,671,757, 6,694,336 or 6,757,696.

The web server 180 allows the user on a computer or other user device 190 having a web browser 192 to configure aspects of the system of the invention. The web server 180 may have a hardware configuration similar to the advanced ID service server 160 and may comprise one or more physical computers. Additionally, the web server 180 may be integrated with the advanced ID service server 160.

In one embodiment, aspects of the system of the present invention are configured via the phone user interface 120. The system can alternatively be configured by the user via a web interface provided by the web server 180 via the user device 190.

FIG. 4 illustrates one process for implementing an invitation (step 212) from a subscriber to a non-subscriber or participant. At step 302, the non-subscriber receives an SMS message from the subscriber. The SMS message may contain all information necessary for the non-subscriber to publish the information into the non-subscriber's data store. In one aspect, this can include all persona information itself in a format which can be read by a native or non-native application such as a SyncML client, a vCard parser, or other application and incorporated into the phone data store. If the non-subscriber accepts the information at step 304, the information populates into the non-subscriber's data store. The next time the subscriber calls, information will be displayed on the non-subscriber's phone.

In another embodiment, shown in FIG. 5, the non-subscriber receives an SMS message from the subscriber at step 404. At step 406, the non-subscriber can select a link stored in the SMS message to connect the non-subscriber's phone to the user info store 106 which sends the subscriber's information directly to the non-subscriber's phone. At step 408, the non-subscriber's phone downloads the information of the subscriber to the phone data store 170 on the non-subscriber's phone.

FIG. 6 illustrates the concept of different personas for different groups of users. FIG. 6 shows a linkage example of different users linked to a central user 600. The central user 600, “Bob”, has a mobile phone which is linked to other users 604, 606, and 602. For each group of users 602, 604, and 606, the central user 600 can establish different personas. A “friend's” persona may show Bob's personal address and home phone number and provide a first type of ringtone. A “co-worker's” persona 604 provides a more formalized name setting, a work e-mail address, and a work phone number with an undefined ringtone. A “client's” persona 606 shows an even more formal name, and includes different work and mobile phone numbers as well as a different ringtone more suitable to provide to Bob's clients.

As shown in FIG. 6, people usually have distinct groups with whom which they communicate including friends, co-workers, and clients. The establishment of different personas allows the publication of different information to each individual. As illustrated in FIG. 1, personas can include names, e-mail addresses, phone numbers, physical addresses, corporate information, pictures, ringtones, URLs, personal physical characteristics (eye/hair color, et al) and birthday information. This information handling is flexible and extensible and can accommodate any additional permanent as well as transient information such as a current time zone, digital certificates, a physical location, including GPS coordinates, and availability.

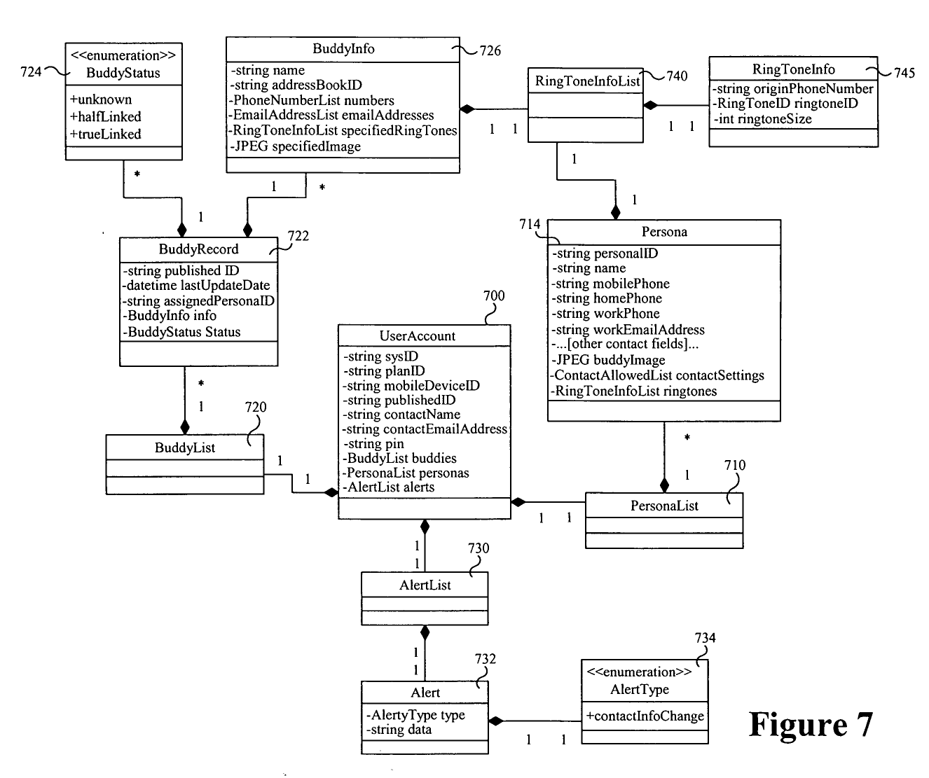

FIG. 7 depicts a static structure of the records maintained for an individual user by the advanced ID service server 160 of the present invention. Each individual user account 700 includes a system ID, a plan ID (indicating a service level description), a mobile device ID, a published ID, a contact name, a contact e-mail address, and a user security pin. The user account 700 will also contain a persona list 710, a buddy list 720, and an alert list 730. The alert list 730 will define a number of alerts 732, each including an alert type 734 and data. The persona list will define a number of personas 714, each including, for example, a personal ID, a name, a mobile phone, a home phone, work phone and other information as specified above with respect to FIG. 1. Other information can include a buddy image, contact list allowed settings, and ringtone information. The ringtone information 740 may be a list of information which links to specific ringtone records 745. Each buddy in buddy list 720 has a buddy list record 722 which includes a published identifier, a last update date (indicating when the buddy record was last updated), a personal identifier, a buddy status identifier 724, and buddy information 726. Buddy information 726 includes a name, address book identifier, phone list numbers, e-mail address lists, image, and ringtone information.

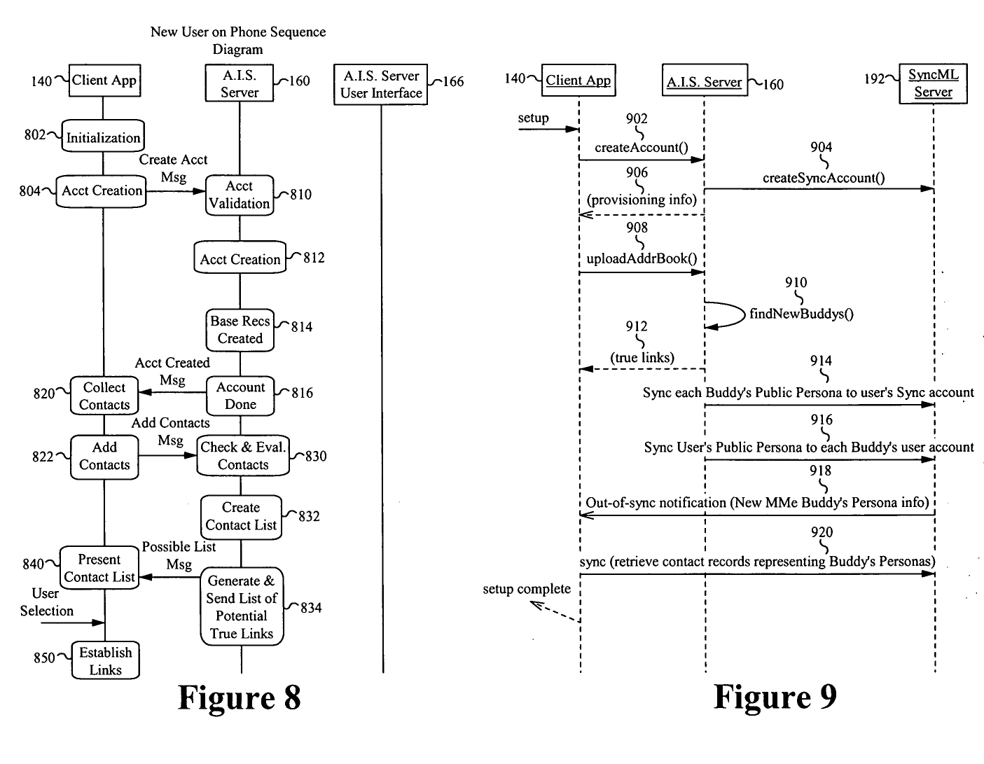

FIG. 8 is a sequence diagram illustrating how a new user can sign up for the advanced caller ID service provided by the enterprise service provider in accordance with the present invention. FIG. 8 shows the sequence of steps which occur between the client application 140 on the phone 100 and the server-side application 175 on the advanced ID service server 160. Upon initialization of the client application 140 at step 802, an account creation process begins at step 804 and sends a create account message to the advanced ID service server 160. At step 810, an account validation process begins, by prompting the new user to provide certain basic information such as name and e-mail contact information to the system. The account validation process at step 810 acquires required information from the new user via the phone user interface 120, and the account is created at step 812 once the required information is provided. Basic account records, including, for example, the information provided in the validation step 810, are created at step 814. Once the account creation step is finished, at step 816, an account created message will be sent to the new user's phone 100. Contacts in the new user's phone 100, which are present in the user's native address book are collected at step 820. At step 822, an add contacts message or data transmission will be sent to the advanced ID service server 160. These contacts will be checked and evaluated at step 830 to determine links between known users in the system already, and users who are not linked in the system. A contact list is created at step 832, and the list of potential true links is generated at step 834. Note that true links can be created and maintained automatically, without user intervention or approval. However, in this embodiment, at step 834, this list is returned to the new user and presented to the new user at step 840. The new user can then select which of those contacts the user wishes to establish links with, and these links will be established at step 850. Optionally the system can establish links with any user who has already established themselves with the system service as a subscriber, who already appears in the new user's local address book.

FIG. 9 is an alternative method for establishing an account with the enterprise service provider wherein a synchronization system of U.S. Pat. Nos. 6,671,757, 6,694,336 or 6,757,696 is used. This sequence illustrates that account creation for such a system requires creation of an underlying sync account with the SyncML server 195, but such account can be created through the advanced ID user interface 166.

At step 902, an account creation step is initiated on the advanced ID service server 160. The advanced ID service server 160 will also create an account with the SyncML server 195 at step 904. The advanced ID service server 160 will provide provisioning information 906 to the client application 140, which will then upload its address book at step 908 to advanced ID service server 160. The advanced ID service server 160 will attempt to establish whether direct links are present at step 910 and return those true links to the new user at step 912. Concurrently, at step 914, the system will attempt to perform synchronization with the new user's contact information on the SyncML server 195. At step 916, the new user's public persona is synced to each user's synchronization account and if there's any problem with the synchronization at step 918 an out of sync notification message is returned to the client application 140. At step 920, records are retrieved regarding the records representing the buddy's personas. Persona records are thereafter synced as other records are synced in accordance with the description in U.S. Pat. No. 6,671,757.

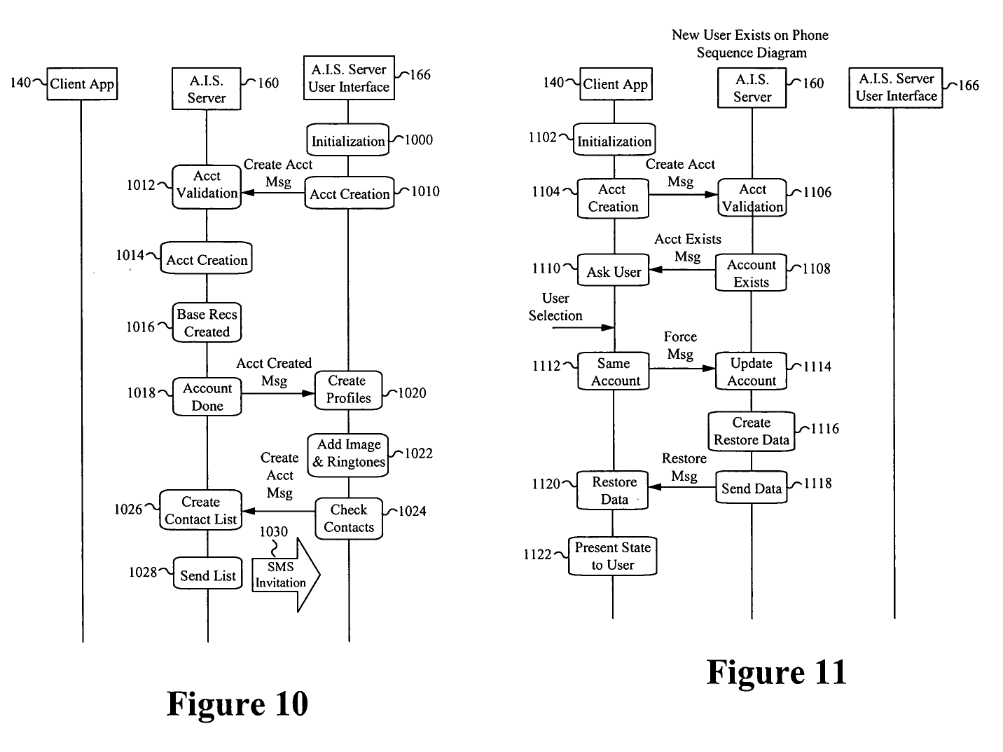

FIG. 10 is a sequence diagram illustrating the establishment of a new user account on the advanced ID service server 160 via the advanced ID service server user interface 166 provided via the web server 180. At step 1000, initialization begins. At step 1010, an account creation interface is provided to the advanced ID service server user interface 166. The new user provides information into the account creation interface and the information is transmitted via a create account message to the advanced ID service server 160. An account validation step will occur at step 1012 after the new user has provided sufficient information to establish an account with the enterprise service provider. Once this occurs, an account creation will occur at step 1014 and base records will be created at step 1016. When the account has been established at step 1018, an account created message will be returned to the user offering the user the opportunity to create personas and providing the new user with a set of default personas at step 1020. The new user will be provided with an initial opportunity to add images and multimedia at step 1022. Next, at step 1024, the new user will be provided with the opportunity to check “buddies” which have been created during the contact link establishment step 208 of FIG. 1. Once the new user has selected which contacts the new user wishes to establish connection with, a contact list will be created at step 1026. The list will be sent back to the new user at step 1028 and may be used to initialize SMS invitations 1030 to those users who are not already established as subscribers with the enterprise service provider.

FIG. 11 illustrates the interaction between the client application 140 and the server application 175 in a situation where an existing user may have lost the user's old phone but already has an existing account with the system. Hence, the existing user merely needs to reestablish connection with the account using the existing user's new phone. At step 1102, initialization takes place. At step 1104, an account creation routine runs on the client application 140 and an account creation message is sent to the advanced ID service server 160. When the account attempts to validate the existing user's information at step 1106, a determination that the account already exists will occur at step 1108. This will prompt a message returning to the client application 140 to ask the existing user at step 1110 whether the account which has been entered is in fact the existing user's account. Once the existing user selects a prompt indicating that it is the same account at step 1112, a message will be returned to the advanced ID service server 160 and the account will be updated at step 1114 with the existing user's new device information. The system may be utilized to restore information to the existing user's new phone by creating a restored data set at step 1116, which may be returned to the existing user at step 1118, and the data is restored in the phone device at step 1120. As such, this restores the existing user's information in the existing user's new phone to the state it was when the existing user last updated the existing user's information on the system's server. At step 1122, the user's information is presented to the user.

As noted above, the client application 140 and server application 175 provide the existing user with a number of functions to create and manage accounts with the ESP and the advanced contact ID system.

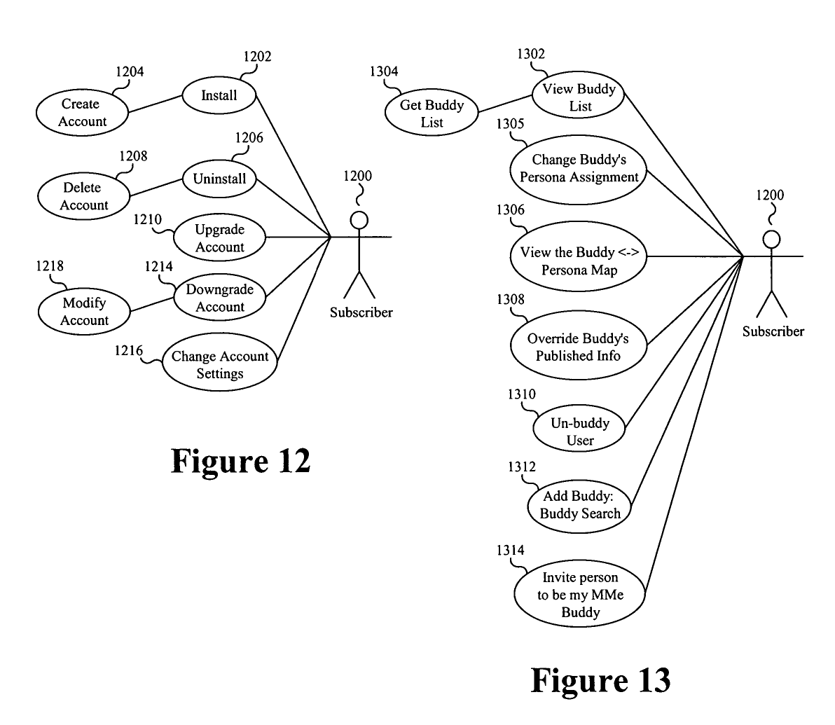

FIG. 12 illustrates functional use cases for a particular subscriber. The particular subscriber 1200 can install an application at 1202, such as by downloading the application to the phone 100 via the phone user interface 120, and create accounts at 1204 in accordance with the foregoing description. Likewise, the particular subscriber 1200 can uninstall the application at 1206 and delete accounts at 1208 with the enterprise service provider. The particular subscriber 1200 can also use the application to upgrade accounts at 1210, downgrade accounts at 1214, and change account settings at 1216 in order to modify an account at 1218.

FIG. 13 illustrates the functions the particular subscriber 1200 can implement to perform tasks linking to other subscribers. The particular subscriber 1200 can view a buddy list at 1302, requiring the buddy list to be retrieved at 1304. Likewise, the particular subscriber 1200 can change a particular buddy's persona assignment at 1305, view a mapping of buddy and personas at 1306, override the buddy's published information at 1308 in the particular subscriber's own address book, such as where a “buddy” had downloaded a ringtone which is not desired by the particular subscriber 1200, remove the buddy from the list of buddies at step 1310, add a buddy by performing a search function at 1312, or invite another person who is not a subscriber to be the particular subscriber's buddy by subscribing to the system at step 1314.

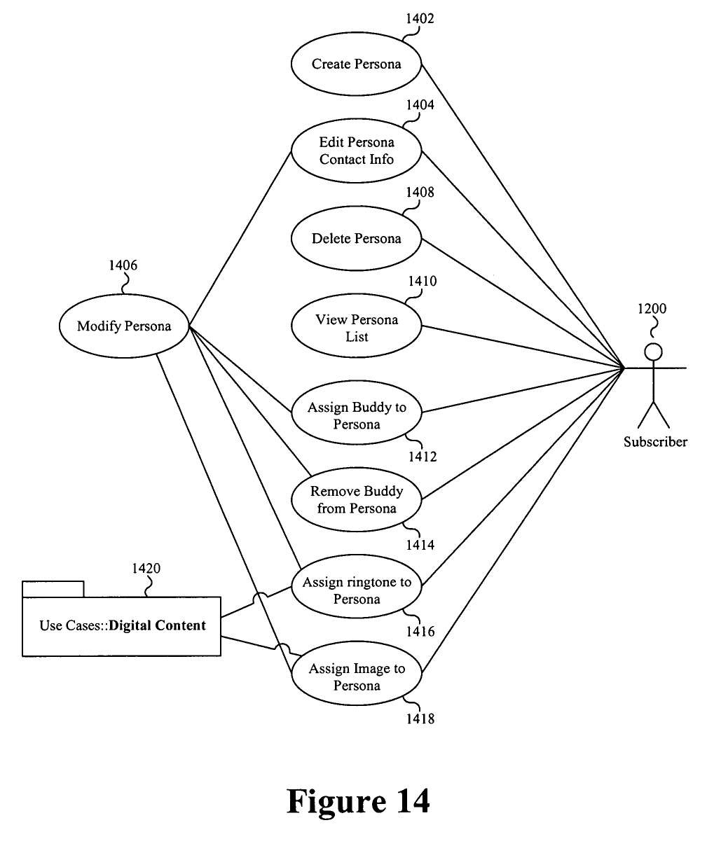

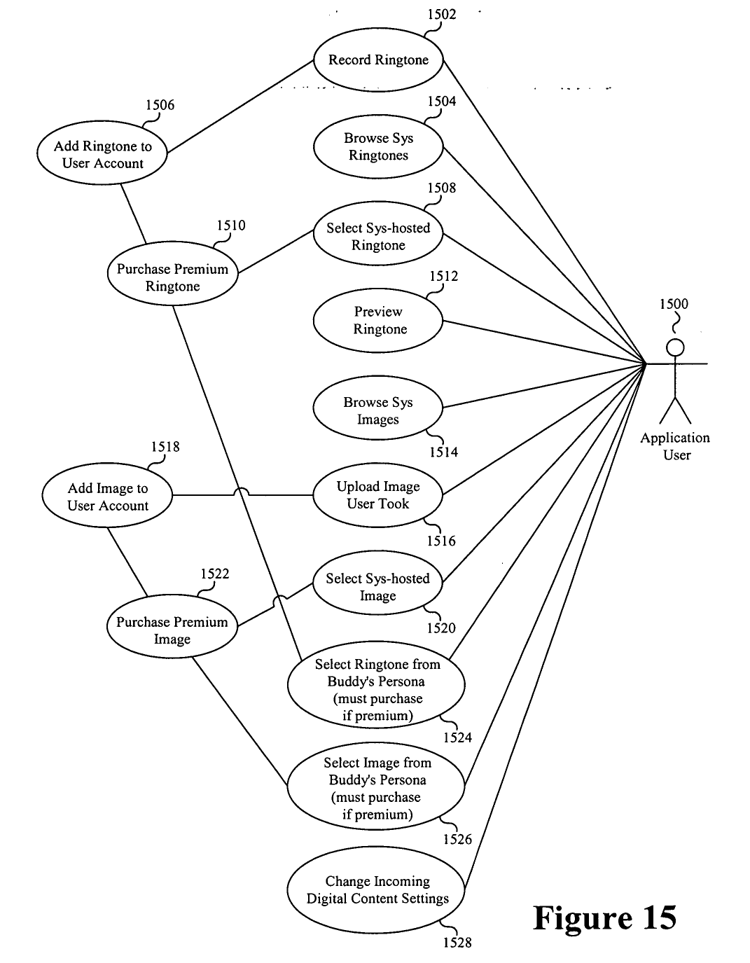

FIG. 14 illustrates use cases for the particular subscriber 1200 with respect to persona manipulation. The particular subscriber 1200 can create persona at 1402, edit personas at 1404 (which results in a modify persona at 1406), delete a persona at 1408, or view a persona list at 1410. Other instances which result in modifying a persona included assign a buddy to a persona at 1412, removing a buddy from a persona at 1414, assigning a ringtone to a persona at 1416 or assigning an image to a persona at 1418. Assigning a ringtone or image also gives rise to the modification of multimedia content at 1420, specifically digital content as illustrated in FIG. 15.

FIG. 15 illustrates the use cases for an application user 1500 interacting with multimedia content. The application user 1500 can record the application user's own ringtone at 1502, or browse system ringtones provides by the value added service provider via the enterprise service provider at 1504. Recording a ringtone at 1502 results in the ringtone being added to the application user's account at 1506. The application user 1500 can also select system hosted ringtones at 1508 and may choose to purchase premium ringtones at 1510. The application user 1500 can also preview ringtones at 1512, and browse system provided images at 1514. The application user 1500 is allowed to upload images 1516 to and from the application user's phone when, for example, the application user's phone supports taking pictures, and adding the image to the application user's account at 1518. The application user 1500 can also choose to select system hosted images at 1520 and purchase premium value added images at 1522. Where the application user 1500 has purchased a ringtone, at 1524, the application user 1500 may choose to share this ringtone with buddies. When a buddy selects the ringtone, digital rights management provider rights in the ringtone may require that the buddy utilizing the ringtone purchase a license to use that ringtone for themselves. Step 1524 allows a prompt where the system asks the application user 1500 requesting the buddy's ringtone for the application user's own use to purchase the ringtone from the enterprise service provider. Likewise at 1526, the buddy's image can be utilized by the application user 1500, and if such image is premium content, a prompt requiring the application user 1500 to purchase the image is provided at 1526. At 1528, the application user 1500 is allowed to change digital content settings in the application user's own phone. If for example the buddy has provided an image and/or ringtone that are unsuitable for the application user 1500, the application user 1500 is allowed to override those settings in the application user's own phone using the application interface. In another embodiment, the media is donated, subsidized, or otherwise provided at reduced or no cost by one party to the other.

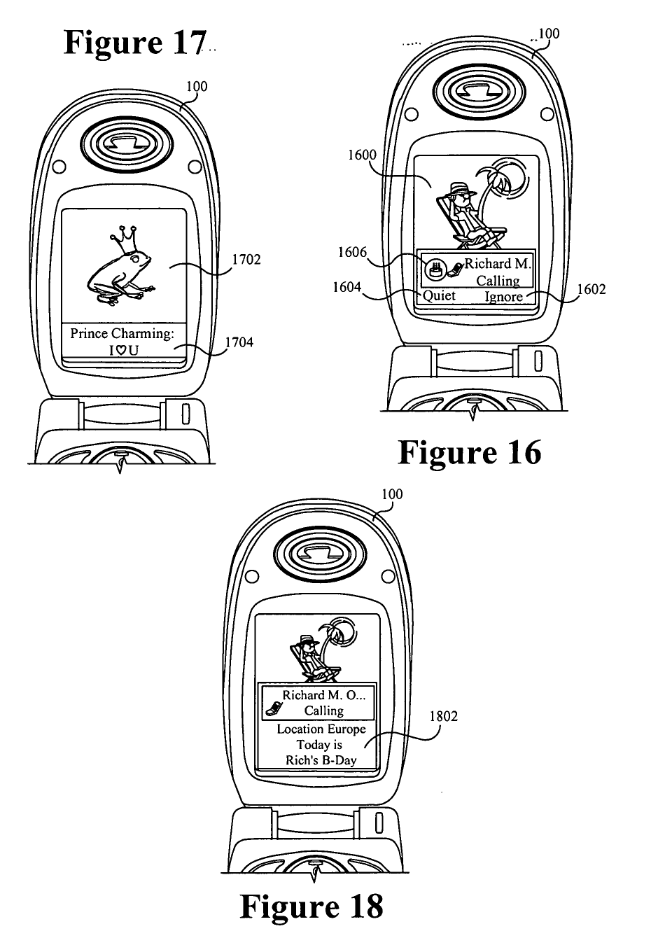

FIGS. 16, 17, and 18 illustrate different aspects of an advanced caller ID function as displayed on a phone 100. Once subscriber information for other users is downloaded to phone 100, displays such as those set forth in FIGS. 16, 17, and 18 may appear.

FIG. 16 shows a first example of a subscriber display. When a calling subscriber “Richard” phones user's phone 100, a display 1600 of the calling subscriber's name and an image that Richard has provided is displayed on the phone 100. Even if the native display of the phone 100 includes only support for a thumbnail image (or an image that does not occupy the entire display area of the phone), the client application 140 can cause the OS services in the phone 100 to display a full screen image along with soft-key enabled function menus 1602, 1604. The display can include an icon 1606 indicating additional information of the calling subscriber. In this example, a birthday cake indicates it is Richard's birthday. As will be understood by those of average skill in the art, many phones include “soft-keys” which activate variable commands in a menu display in a phone. Selection of the soft-keys (generally directly under an interface screen) in the example of FIG. 16 provide ignore prompt 1602 and a quiet prompt 1604.

FIG. 17 shows a depiction of a movie display 1702 on the phone device 100 with a text message 1704 displayed underneath. It will be understood that the image in FIG. 17 is, for example, an AVI, MPEG, QuickTime, or other sample video image supported by the playback features of the phone 100.

FIG. 18 is another example of a display for “Richard” wherein additional meta data is provided. This information is depicted in a text message at the bottom portion 1802 of the screen, and includes location information as well as information indicating that today is Richard's birthday.

In a further embodiment, the subscriber display may be provided which incorporates data from sources other than the address book. If, for example, the user has populated a phone's native calendar with information concerning meetings with a contact, the client application 140 can extract this information and display, for example, the user's last or future meetings with the contact. Alternatively, this information can be extracted from a sync user account when a synchronization server is utilized as described herein.

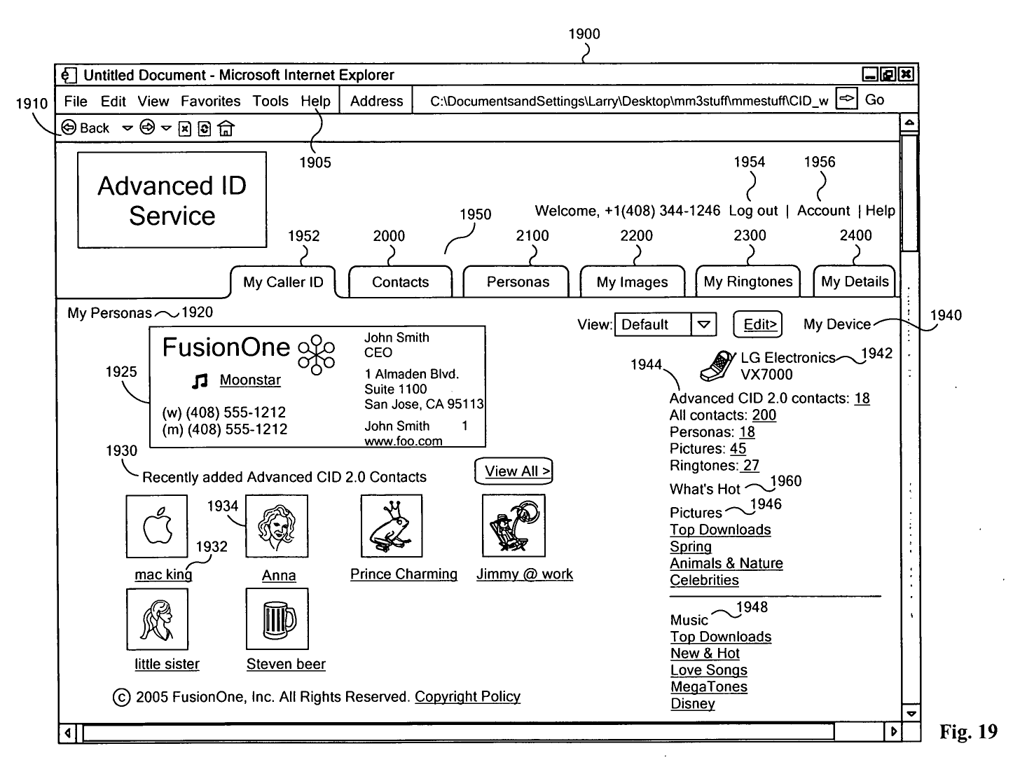

FIG. 19 is a depiction of a user interface 1900 which may be provided by the advanced ID service server 160 via web server 180 to the client device 190. A typical web browser 1910 includes a browser menu bar 1905 having a number of standard features well recognized to those of average skill in the art, including navigation features for the world wide web. User interface 1900 may be accessed via URL supplied by the web server 180. The user interface 1900 includes a menu bar 1950 having a My CallerID link 1952, a Contacts link 2000, a Personas link 2100, a My Images link 2200, a My Ringtones link 2300 and a My Details link 2400. The welcome screen includes a logout account link 1954 and a help link 1956 and displays a welcome message to a user based on the user's telephone number.

A window for My CallerID is divided into multiple sections. A My Device section 1940 displays the system's understanding of the user's current type of device at 1942, status information 1944 including the number of contacts the user has specified as direct link contacts “Advanced CID 2.0 contacts”, the number of total contacts the user has, the number of personas the user has, the number of pictures the user has, and the number of ringtones the user has. An additional section labeled “What's hot” 1960 can be utilized by a value added reseller to display digital content such as pictures 1946 and music 1948 which allow the user to download this information from the value added service provider and provided to the user's account. A My Personas section 1920 includes a depiction of contact card 1925 for the user John Smith which includes the user's general information. A recently added advanced CID (ACID) contact section 1930 displays links to user's contacts as hyperlinks 1932 along with a graphic depiction 1934 associated with that contact. It will be understood that each of the terms on the page highlighted by underlining can provide a hyperlink to more detailed information about the links content.

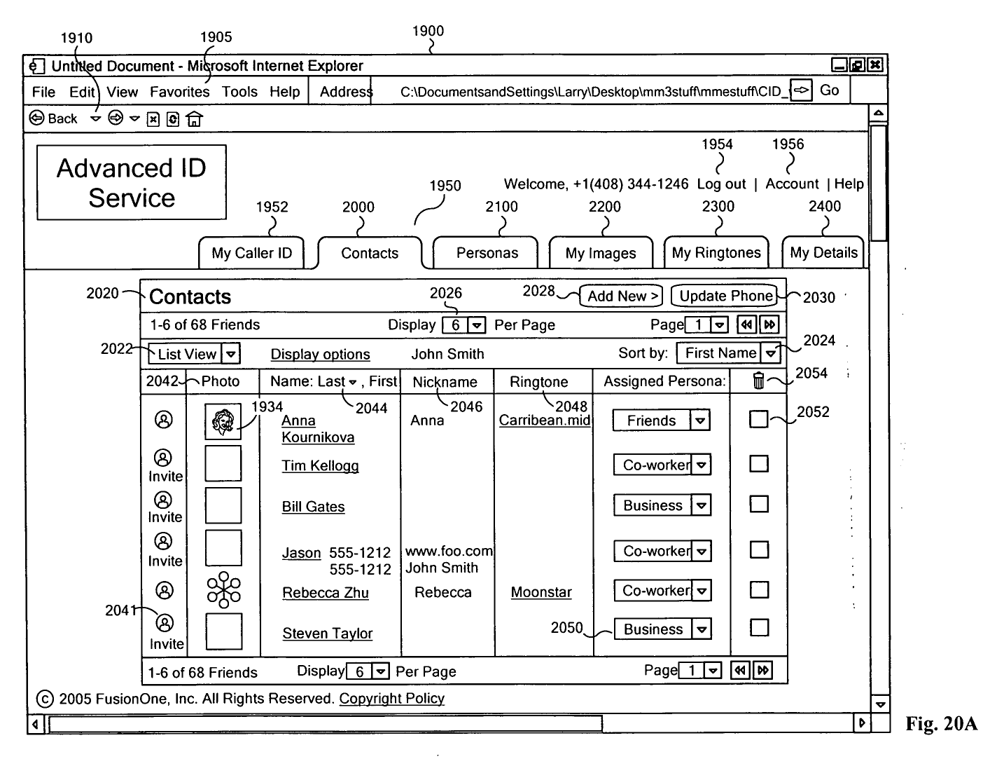

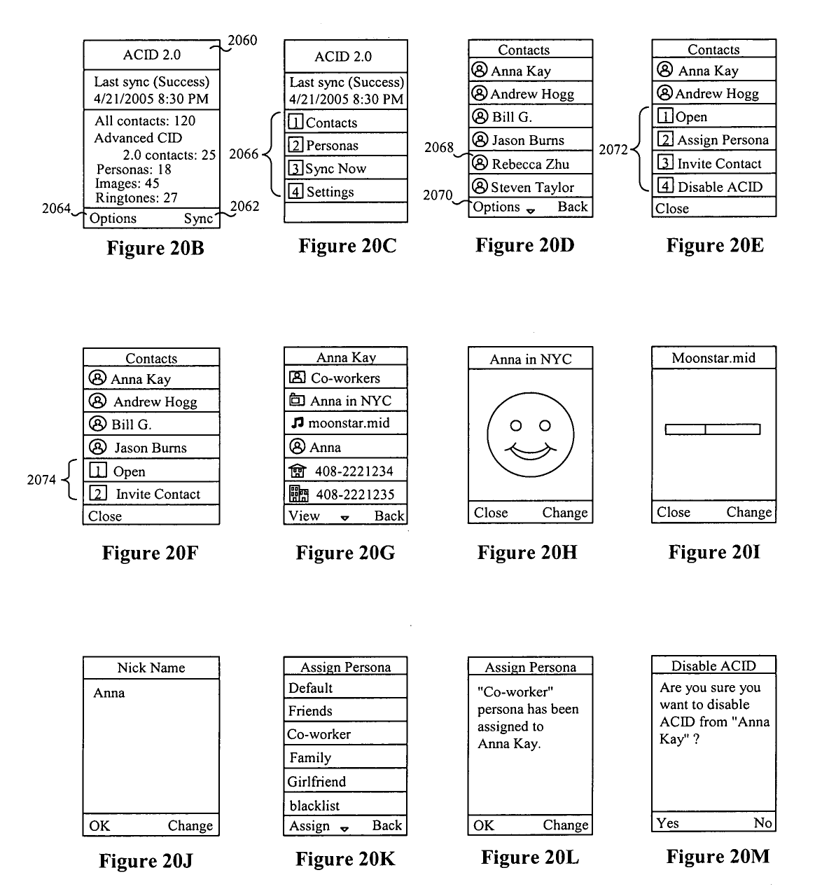

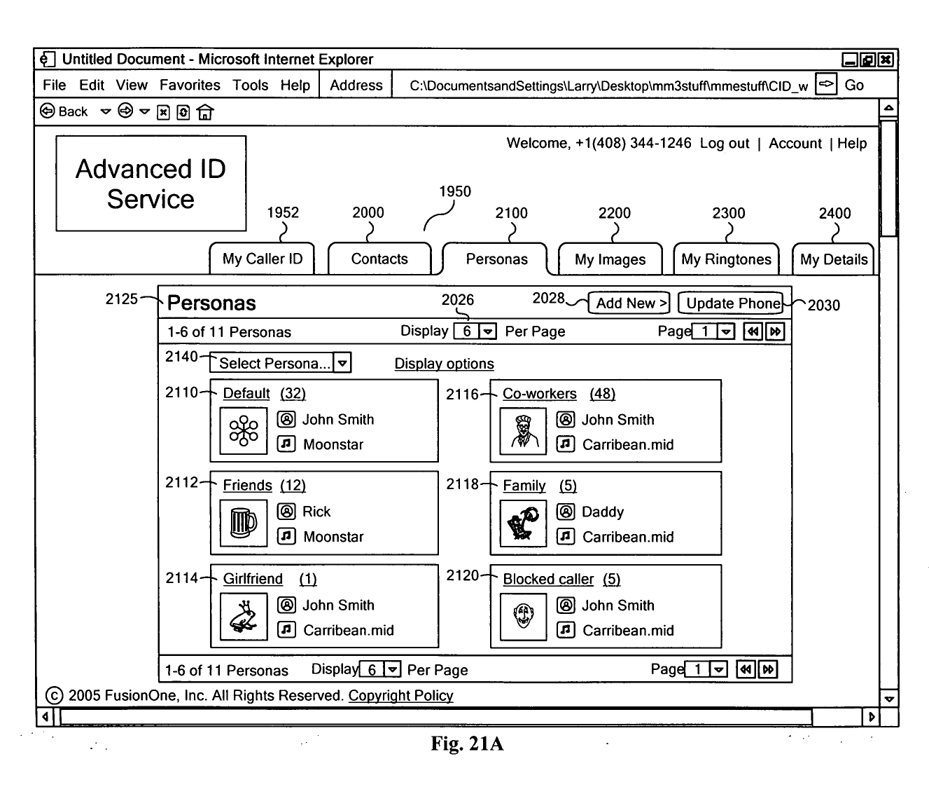

Selection of the Contacts link 2000 on the menu bar 1950 gives rise to the user interface 1900 shown in FIG. 20A which allows the user to manage the user's contacts in the system of the present invention. The user interface 1900 includes a Contacts window 2020 which provides the user a number of options for listing and editing contacts. The user can choose from any of a number of different types of view via a drop down box 2022. The view shown in FIG. 20A is that of a list view for a series of contacts. Selection of a number of contacts via a drop down box 2026 allows that number of contacts to be displayed per page. Each contact includes a photo depiction in column 2042, a name display in column 2044, a nickname field in column 2046, a ringtone associated with that user in column 2048, an assigned persona which may be selected via drop down boxes in column 2050. Likewise, each user is associated with an invite link in column 2041 and a tick box in column 2052. The tick boxes allow the user to select one or more contacts for immediate deletion via selection of a delete icon 2054. Selection of one of the hyperlinks of a contact will cause the web server 180 to render an edit page allowing the user to edit information associated with that contact. The contacts are sorted in a particular manner via a drop down box 2024. The user can add a new contact via an add new button 2028 and update the phone via update phone button 2030.

The functionality associated with the user interface in FIG. 20A on the web browser 1910 can likewise be provided on a screen of a user phone. FIGS. 20B-20M depict the contact interface which is displayed on the user phone.

FIG. 20B shows an initial start-up screen 2060 displaying a “last successful synchronization” that the user has made as well as status information (all contacts, advanced CID contacts, personas, images and ringtones) such as that depicted in FIG. 20A. Options provided to the user at this point by soft-key menu items allow the user to initiate a sync at 2062, or select different options at 2064.

FIG. 20C shows a menu 2066 resulting from selection of the “options” soft-key 2064 in FIG. 20B. The menu 2066 allows the user to select a contacts link, a personas link, a sync now instruction link, or a settings link.

At FIG. 20D, if the user has selected the contacts link in FIG. 20C, a list of contacts 2068 is displayed. The user can use the soft-keys and any other input device on the phone to highlight a contact in the display for selection. Selection of a contact opens a record for that contact. Optionally an options soft-key 2070 is displayed depending on whether the contact is an advanced CID contact or not.

At FIG. 20E, the user may display an options menu 2072 for an advanced CID contact by selecting the options soft key 2070 in FIG. 20D. This options menu 2072 allows the user to open the contact, assign a persona to the contact, invite the contact into subscription with the system of the present invention, or disable advanced CID for that particular contact. Alternatively, FIG. 20F shows an options interface 2074 if a contact which has been selected in FIG. 20D is not an advanced CID contact. The only two options available for the user in FIG. 20F are to open the contact or invite the contact into subscription with the system.

If an advanced CID contact is opened (from FIG. 20E), the screen of FIG. 20G is displayed. The depiction of FIG. 20G shows that, for example, Anna K is a member of the co-workers persona, has a picture assigned entitled “Anna in NYC,” is assigned the moonstar midi (moonstar.mid) ringtone, has a nickname “Anna” and has a work number and a home number associated with her contact information. Each of these items is selectable by moving a selection input on the phone and depressing an entry button. For example, pressing the Anna in NYC selection will result in the display shown in FIG. 20H wherein a graphic image associated with the contact is displayed. Selecting the moonstar midi ringtone will result in playing the ringtone in the depiction shown in FIG. 20I. Selecting the nickname will allow the user to change the nickname via an interface 20J displayed on the phone.

Selecting the assign persona (from FIG. 20E) brings up an assign persona menu as shown in FIG. 20K. The assign persona menu will display current personas which are associated with the user and allow the user to select one or more personas to assign the particular contact to. If the user selects, for example, the co-worker persona, a message such as that shown in FIG. 20L will be displayed indicating to the user that the co-worker persona has been assigned to Anna K.

Finally, if the user selects to disable advanced CID from the options interface shown in FIG. 20E, a warning message is displayed such as that shown in FIG. 20M.

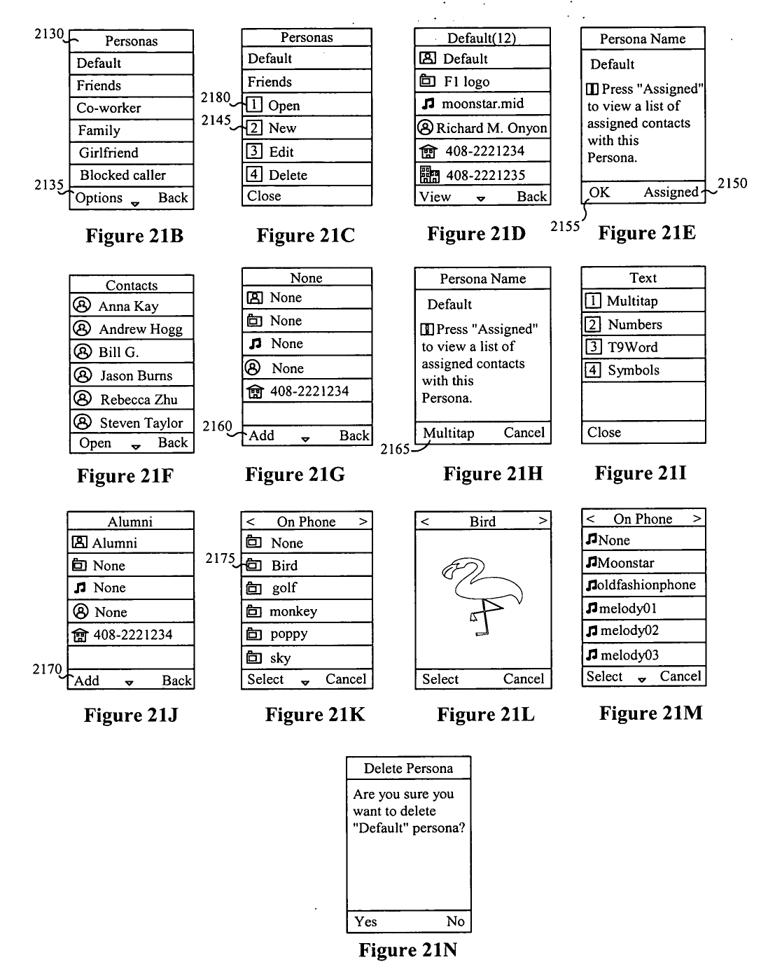

Pressing the “personas” menu item 2100 in menu bar 1950 displays a personas interface 2100 shown in FIG. 21A. As shown in FIG. 21A, the user interface 1900 includes a Personas window 2125 displaying a table of personas 2110, 2112, 2114, 2116, 2118, and 2120 which provides the user with a short display of name of the persona, the number of users to whom the persona is assigned in parentheses, and an image the user is displaying in the persona to others, the name the user is displaying to others and the ringtone the user is displaying to others. It should be recognized that components of the interface include additional components of the persona, or less components of the persona depending on the real estate available on the user interface on the web page. The user can choose a particular persona to display via a pull down box 2140.

FIGS. 21B-21N illustrate the same functionality provided in the Personas window 2130 on the user phone.

FIG. 21B shows a personas menu 2130 which includes links to each of the defined personas for the user. In FIG. 21B, these are default, friends, co-worker, family, girlfriend, and blocked caller. Selection of the options soft-key 2135 gives rise to a menu shown in FIG. 21C allowing the user to open, create a new persona, edit a current persona, or delete a current persona. If a user selects to open 2180 a persona such as the default persona, the display shown in FIG. 21D is shown. The display in FIG. 21D shows that for a given “default” persona, the name of the persona is displayed, the associated image “F1 logo” is displayed, the ringtone “moonstar.mid” is displayed, the nickname associated with the persona is displayed and a work number and home number associated with the persona is displayed. Selection of the persona name by navigating to the name and selecting using a phone input selection mechanism results in the display shown in FIG. 21E, offering the user soft-keys “ok” 2155 and “assigned” 2150. Selection of the assigned soft-key 2150 results in the display shown in FIG. 21F, showing the users which have been assigned to this particular persona by the user.

Currently returning to FIG. 21C, selection of the “new” menu item 2145 results in a template shown in FIG. 21G. All the items in the template are blank, allowing the user to add via the add soft key 2160. The only menu entry which is pre-populated is the user's phone number as shown in FIG. 21G. Depressing the add soft key 2160 in FIG. 21G results in the display in FIG. 21H, allowing the user to enter via the phone's text entry method the name of the persona. FIG. 21I shows a menu by selecting the “multitap” soft key 2165. The menu in FIG. 21I allows the user to choose from several input methods for text such as multitap, numbers, T9 word entry, or symbols. Once the name has been specified in FIG. 21H, the display of FIG. 21J illustrating the name of the persona is displayed. FIG. 21K results when the user has selected the add soft-key 2170 in FIG. 21J. FIG. 21K displays those graphical or image entries which are “on the phone” and allows the user to select one of the displayed entries. If the user selects the “bird” entry 2175 the image that's displayed is shown in FIG. 21L. Likewise, FIG. 21M displays a list of ringtones available for the user. FIG. 21N displays a user's availability to delete a persona, when delete is selected in FIG. 21C.

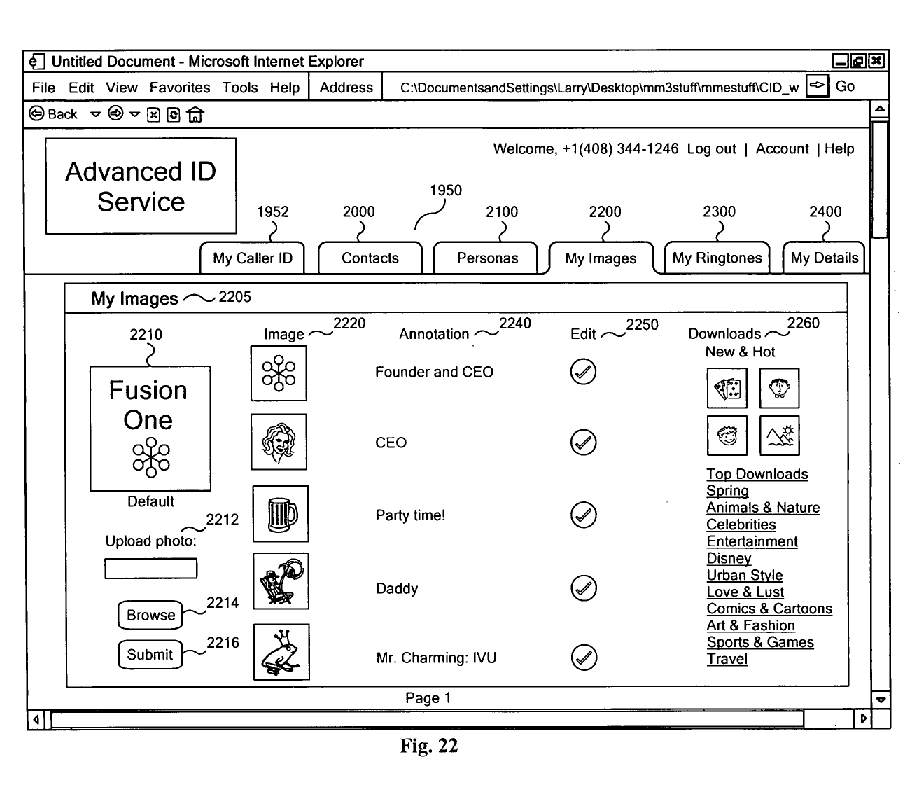

FIG. 22 illustrates a user interface 1900 displayed in the web browser allowing the user to manage images in accordance with the present invention. The user interface 1900 includes a My Images window 2205. Images available to the user are displayed in a column 2220, along with an associated nickname in column 2240, and an edit function hyperlink in column 2250. A default image for the user 2210 is displayed such that should the user create personas, the default image will be used. An upload interface 2212 including a browse selection button 2214 and a submit button 2216 are provided allowing the user to upload various images to their account. A premium downloads section 2660 offers the user links to value added service provider content to be downloaded and utilized by the user in accordance with the terms of the value added service provider.

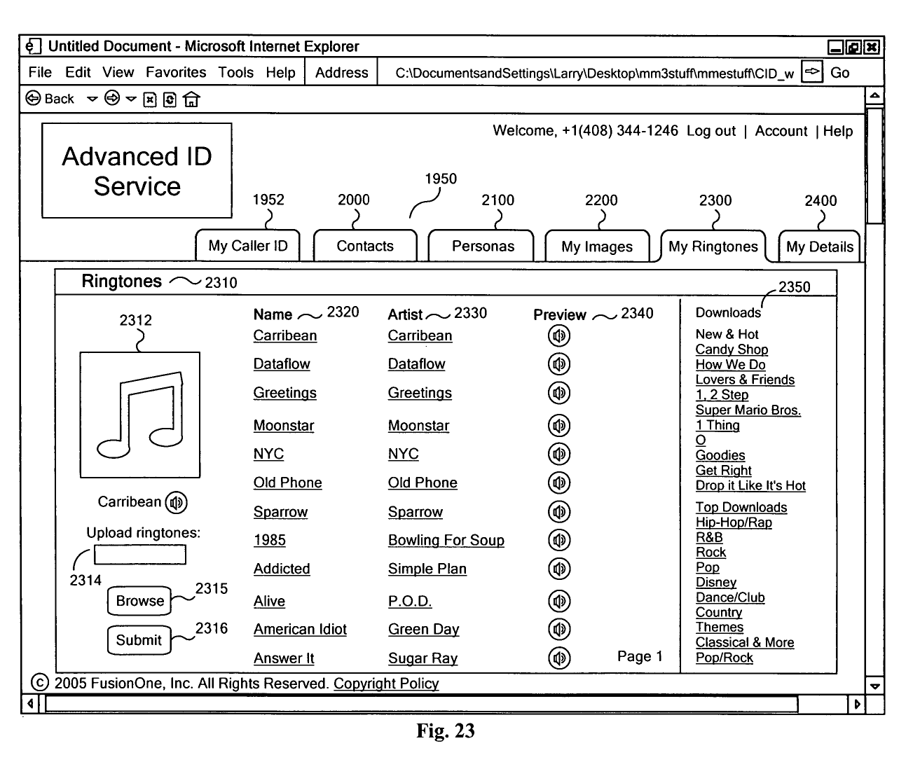

FIG. 23 illustrates a user interface 1900 displayed in the web browser allowing the user to manage ringtones in accordance with the present invention. A My Ringtones window 2310 includes a list of ringtones 2320 which have been uploaded or are available to the user via their account. The name of the ringtone is displayed in column 2320, the artist in column 2330 and a preview in hyperlink 2340. Likewise, default ringtone for the user is displayed at 2312. Again, a value added download section 2350 can be provided to allow a digital content provider to provide value-added content downloadable by the user via this interface. An upload interface 2314 including a browse button 2315 and submit button 2316 allow a user to add to the ringtone selections for his account In a well known manner.

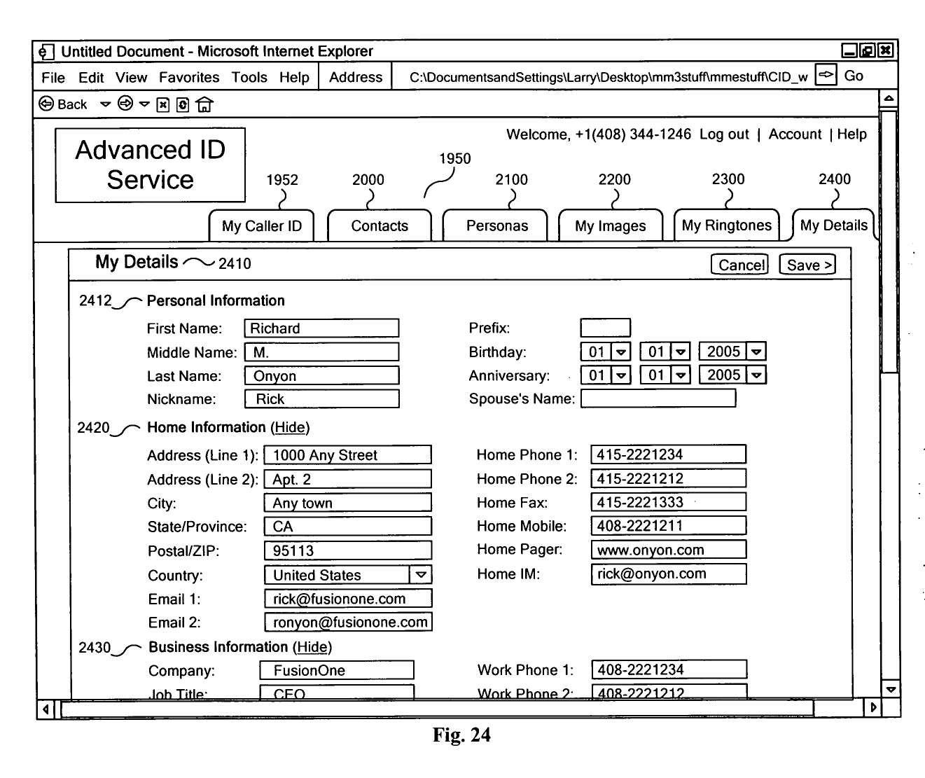

FIG. 24 illustrates a My Details window 2410 upon selection of My Details link 2400 in the menu bar 1950 of FIG. 24. The My Details window 2410 allows the user to manage information associated with the user's account. A personal information section 2412 allows the user to input and change the user's first, middle and last name, as well as the user's nickname and detailed personal information, such as their birthday, anniversary and spouse's name. A home information section 2420 and business information section 2430 allow the user to specify a number of contact points and contact numbers for the user which are then used to allow the user to create personas in accordance with the foregoing description.

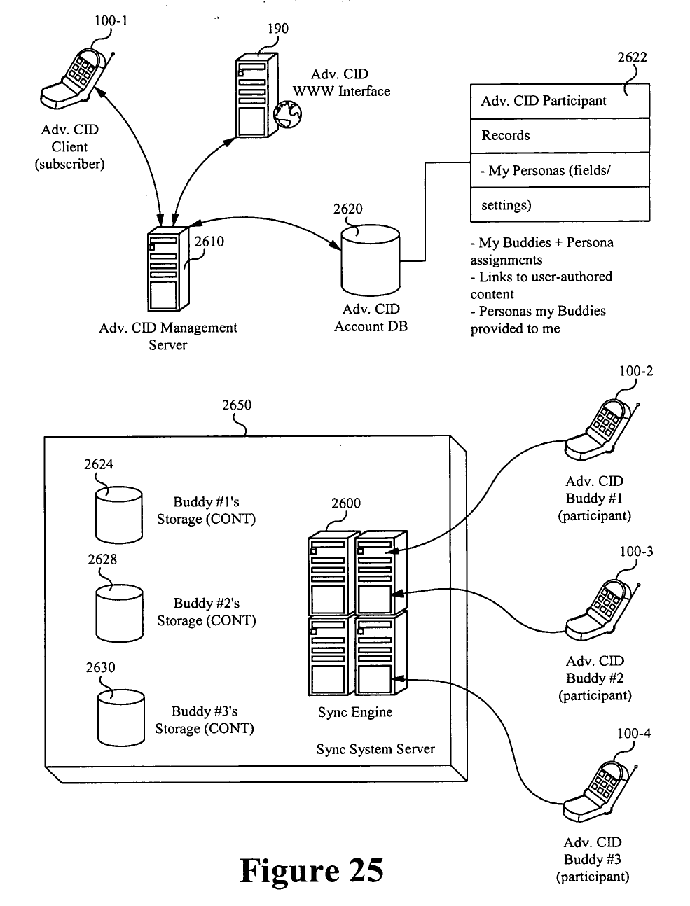

As noted above, when the system is implemented in accordance with a synchronization system as shown and described with respect to U.S. Pat. Nos. 6,671,757, 6,694,336 or 6,757,696, additional elements other than those shown in FIG. 3 may be present. FIG. 25 is a block diagram illustrating how the integration between a number of users and the synchronization server system 2650 implemented in accordance with U.S. Pat. Nos. 6,671,757, 6,694,336 or 6,757,696 as used in to the present invention. An advanced CID management server 2610 may comprise the advanced ID service server 160 or a sub-set of the elements of the advanced ID service server 160, but including at least the server-side application 175 and the user info store 106 to an advanced CID account database 2620 containing subscriber records 2622. A sync engine 2600 within the synchronization server system 2650 is provided with sync account records 2624, 2628, 2630 for a number of buddies 100-2, 100-3, and 100-4 of a subscriber 100-1. Synch server system 2650 communicates the synchronization mechanism disclosed in U.S. Pat. Nos. 6,671,757, 6,694,336 or 6,757,696 with buddy users 100-2, 100-3, and 100-4. Rather than directly communicating changes via a download and upload of data, the transaction data packages as disclosed in U.S. Pat. Nos. 6,671,757, 6,694,336 or 6,757,696 communicate persona information by distributing changed logs to the buddy users 100-2-100-4. The user communicates with the advanced CID management server 2610 via the phone user interface 120 or web interfaces on a client device 190 as previously described.

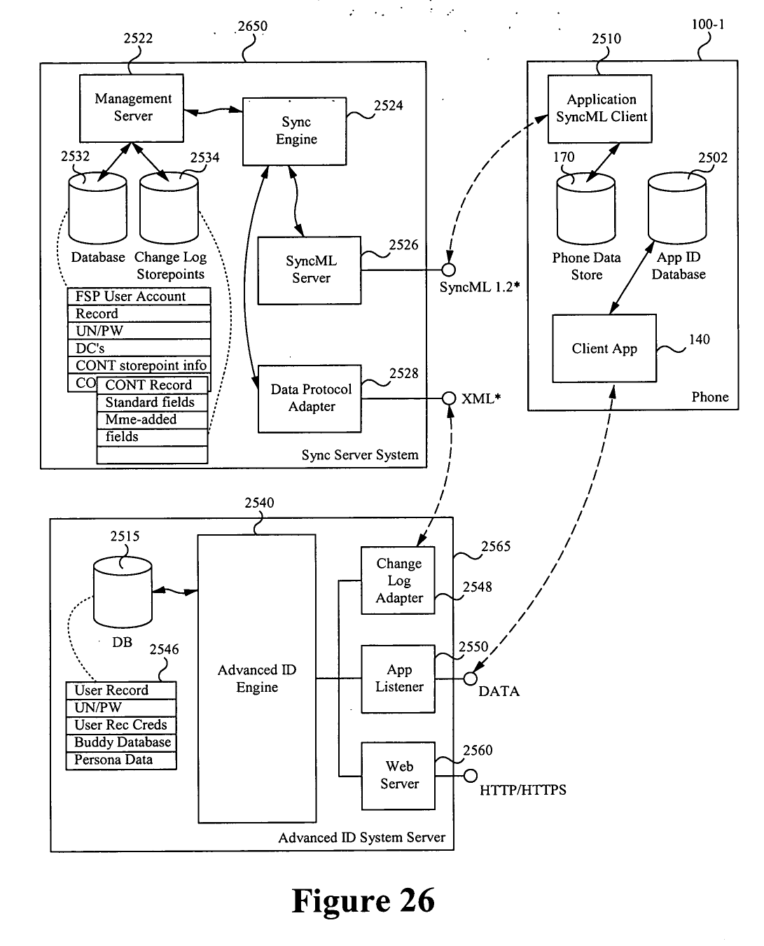

FIG. 26 is a block diagram depicting a more detailed alternative configuration of a sync server system, advanced ID system server and client system for implementing the present invention. In FIG. 26, the sync server system 2650 is depicted as a stand-alone device communicating with a client such as a phone 100-1. In FIG. 26, the phone 100-1 is depicted as including a client application 140 as well as synchronization client 2510, such as that described with respect to U.S. Pat. No. 6,671,757. An advanced ID system server 2565 includes a database 2515 having user content records 2546, which include personas stored for subscribers as previously described. The advanced ID system server 2565 also includes a web server 2560 providing the web based interface screens disclosed in the foregoing figures. An application listener engine 2550 communicates with the client application 140 to allow the user to input changes directly to the advanced ID system server 2565. A change log adapter engine 2548 allows communication of changes to and from the synchronization server system 2650. The synchronization server system 2650 communicates with the synchronization client 2510 via a SyncML server 2526 and with the advanced ID system server 2565 via a data protocol adapter 2528. A management server 2522 as described in U.S. Pat. No. 6,671,757 communicates with a synchronization engine 2524 to control synchronization data packages stored in a database 2532. The system allows the user's information to be stored across any number of multiple devices, and allows users having accounts with the synchronization server system 2650 to have their information incorporated into the subscriber's advanced contact ID system. Each user account with the advanced contact ID service in the present invention requires the creation of corresponding synchronization account of the user. The synchronization account is used to synchronize the user's contents between the device 100-1 and the advanced ID system server 2565. The advanced ID system server 2565 modifies the appropriate contact in the user's persona and information.

The personal records may be represented in the synchronization server system's content records by a specially added contact record field. When a change log describing a persona arrives at the application listener engine 2550, the advanced ID engine 2540 collects the affected buddies, finds the corresponding synchronization server record 2546, and provides the contact modified transaction change log containing the new persona information back to the change log store points 2534 within the synchronization server system 2650. The synchronization server system 2650 adds these modified transactions in accordance with the description of U.S. Pat. Nos. 6,671,757, 6,694,336 or 6,757,696 to the directly linked buddies' synchronization accounts. On such buddies' next synch, each party retrieves the updated contact record representing the persona that the user has assigned it to. Once the synchronization server system 2650 contacts the advanced ID system server 2565, the advanced ID system server 2565 tracks which persona a given buddy is assigned to by adding a field to the contact record. Device 100-1 incorporates the synchronization client 2510 which syncs with the device's address book with change logs provided by the change log store points 2534 in the synchronization server system 2650. Both the native phone data store 170 and the application ID database 2502 may be used to store records for the advanced contact ID system in accordance with the present invention.

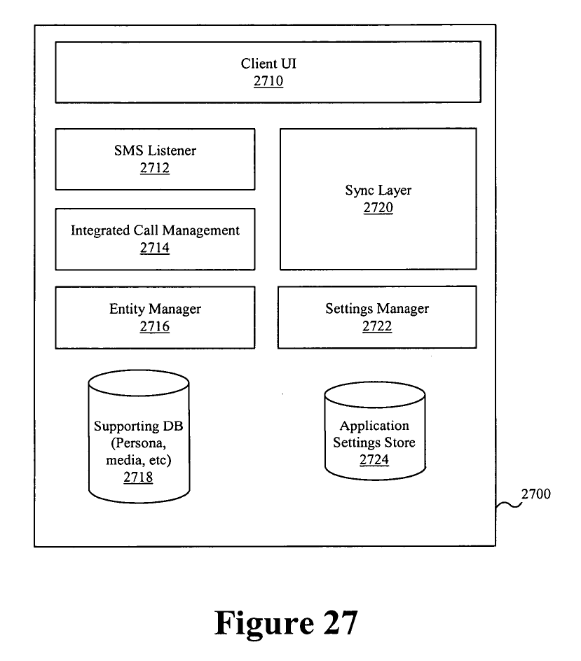

FIG. 27 depicts a client side application including a number of subsystems. A client application 2700 includes user interface 2710, an SMS listener 2712, integrated call management 2714, an entity manager 2716, a supporting database 2718, a synchronization layer 2720, if utilized with the technology of U.S. Pat. No. 6,671,757, a settings manager 2722, and an application settings data store 2724. Client application 2700 includes the user interface 2710 which displays the interface screens of the present invention as previously described. In various configurations, portions of the phone's native address book 3150 and supporting database 2718 store advanced contact ID information on the device. As noted above, when a subscriber contacts phone 100-1, the client application 2700 accepts the inbound call and depending on the robustness of the supported device and displays a custom user interface, including for example, a full screen image overlay with meta data, or a video clip. The integrated call management 2714 allows the user a variety of options to dispense with the call, such as answering, sending it to voice mail, or blocking the call to automatically populate the address book with the caller's public information. The entity manager 2716 maintains persona and buddy information on the client itself, as discussed below. The Sync layer 2720 supports synchronization with a sync server such as that described in U.S. Pat. No. 6,671,757. The settings manager 2722 maintains the user's preferences with respect to the application (such as application defaults and when the user may not want to be disturbed), which are stored in application settings store 2724. The client application 2700 also receives short messages via the SMS listener 2712.

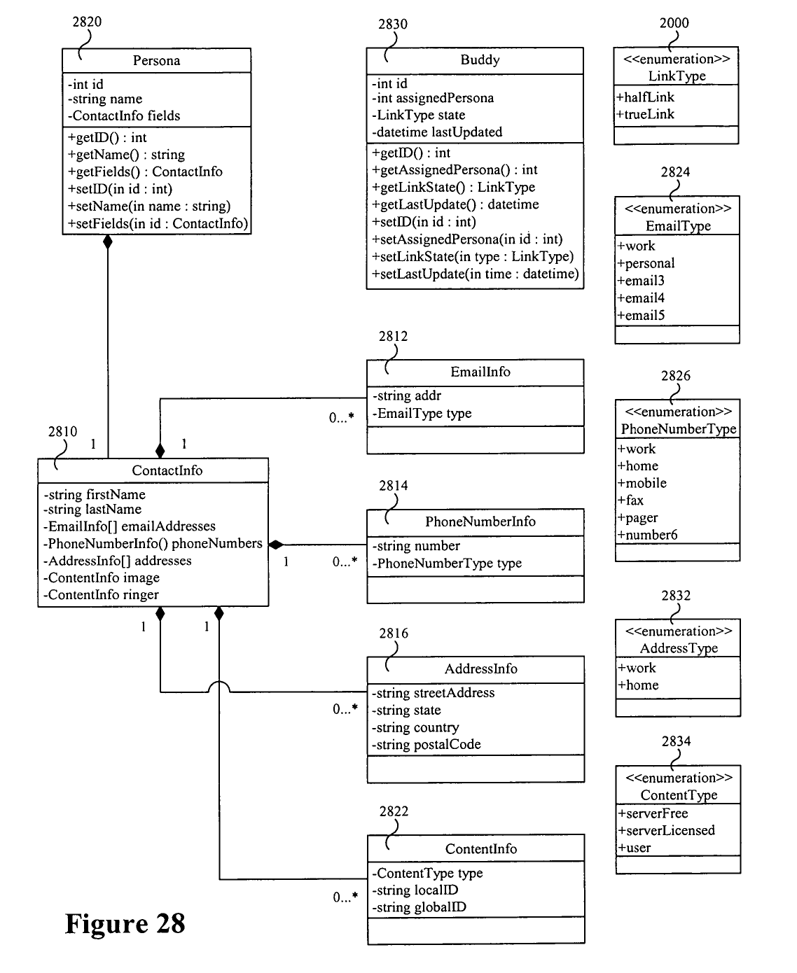

FIG. 28 is a static illustration of the fundamental client objects utilized in the supporting database 2718 alone or in conjunction with a native database. As shown in FIG. 28, for each instance of content information 2810 for a user, the instance may include email information 2812, phone number information 2814, address information 2816 and other content information 2822 such as a local ID and global ID. Each contact instance 2810 is associated with a persona 2820 and each persona identified by an identifier associated with the user. Buddy records 2830 include a buddy identifier, an assigned persona, what type of buddy they are (link type 2000) and a field indicating when the buddy information was last updated. Likewise, the e-mail information includes e-mail type enumeration 2824, phone number information 2814 includes phone number enumerations 2826, address information 2816 includes address enumerations 2832 (for work or home addresses), and content information 2822 includes for digital content, whether it is free or licensed information 2834.

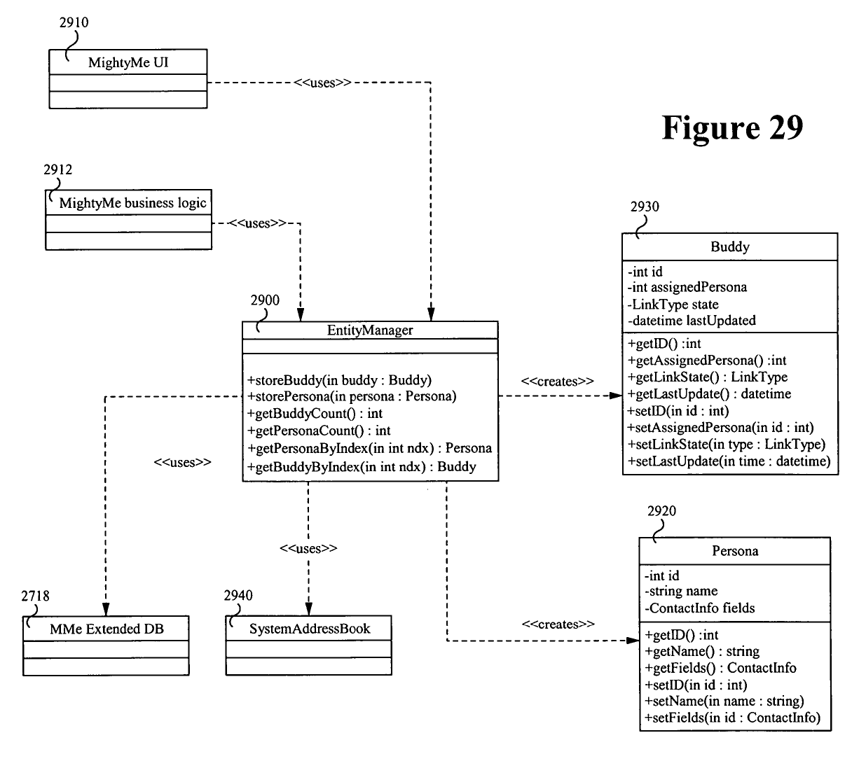

FIG. 29 is a depiction of the entity manager 2716 shown in FIG. 27. Personas and buddies are collectively referred to as entities and are handled by the entity manager 2900. As noted above, very few available devices support sufficiently robust address book data required for the implementation of the system in the present invention. To support the new data types required for this system, extended supporting database 2718 depicted in FIG. 27 may be required. Entity manager 2900 controls the use of these two data stores. Due to the peculiarities at the particular platform in question, entity manager 2900 creates a serialized a buddy record 2930 and persona record 2920 and uses the system address book 2940 and the supporting database 2718. The user interface 2910 and business logic 2912 use the entity manager 2900. Entity manager 2900 gathers the serialization code in a central place and allows expansion of the data set to include additional fields.

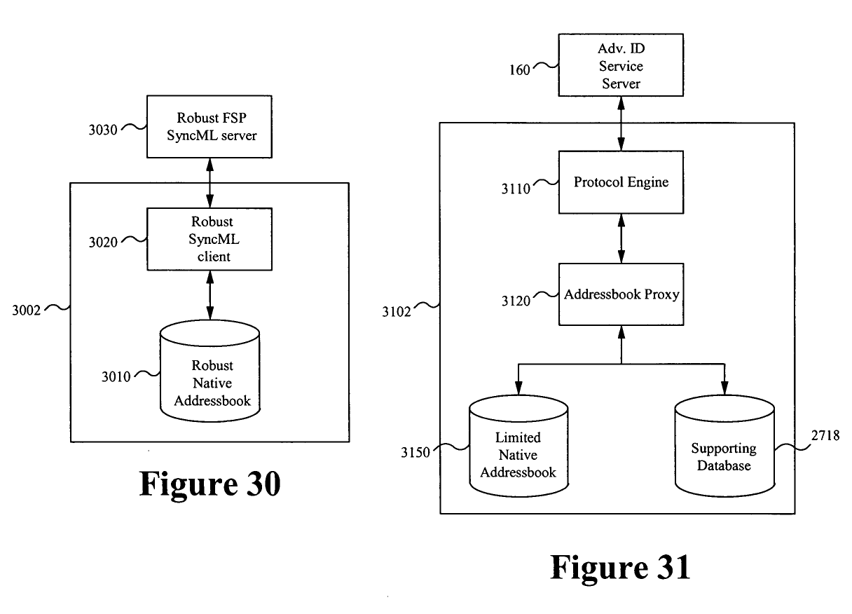

FIGS. 30, 31, 32, 33, and 34 illustrate alternative configurations for the client application shown in FIG. 27. An optimal configuration 3002 is shown in FIG. 30 wherein a native robust address book 3010, a robust SyncML client 3020, and a robust synchronization server 3030 are provided. In this configuration, there may be very little for the client application 3002 to do, other than managing multimedia content presented to the user interface. Most of the management and push of persona information occurs on the robust synchronization server 3030.

Since most current clients do not include native robust address books and SyncML clients, FIG. 31 presents an alternative configuration allowing a client application 3102 to communicate with an advanced ID service server 160. The advanced ID service server 160 communicates with client application 3102 via a shared communications protocol as shown in FIG. 31. Client application 3102 includes a protocol engine 3110 and an address book proxy 3120 and utilizes both the limited native address book 3150 and supporting database 2718. The address book proxy 3120 (such as entity manager 2900 or some other form of proxy mechanism) manages communications and storage of information between the respective stores 2718 and 3150.

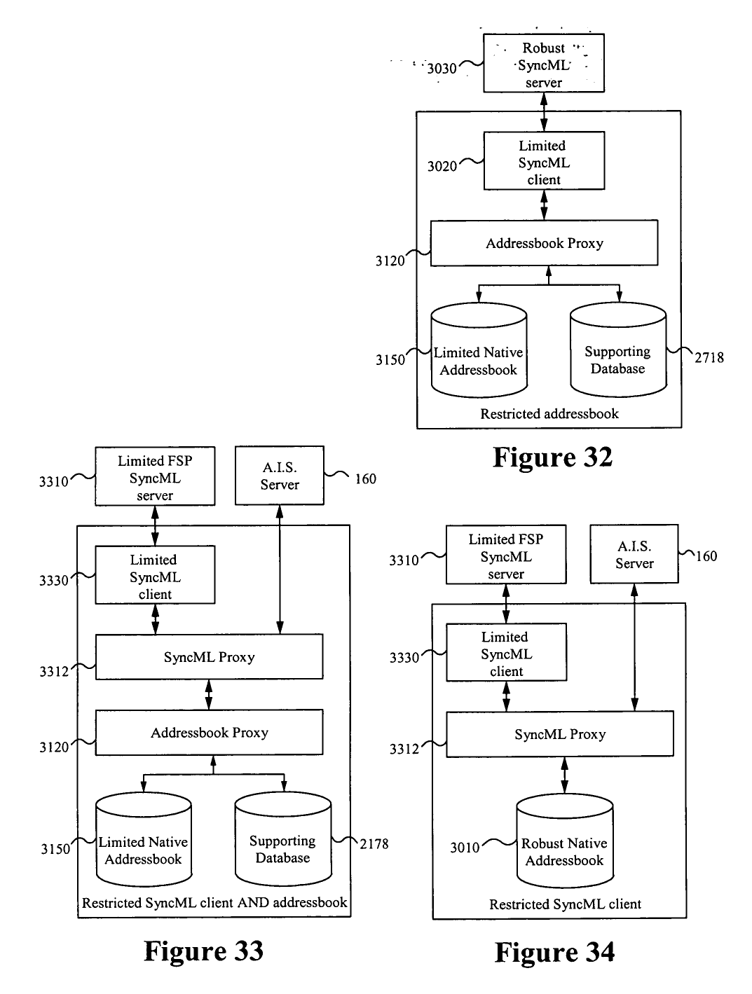

Yet another alternative configuration is shown in FIG. 32. In FIG. 32, the robust SyncML server 3030 communicates with the robust SyncML client 3020, but utilizes the address book proxy 3120 to split information between the supporting database 2718 and address book 3150.

In FIG. 33, a limited SyncML server 3310 provides support for some synchronization information required for the persona, but not all the necessary information required. Likewise the phone's limited SyncML client 3330 may only support limited synchronization or field support. For example, the advanced ID service server 160 may support address and phone number synchronization but not downloading of movies and ringtones. In this embodiment, the limited SyncML server 3310 cooperates with the advanced ID service server 160 to communicate certain information via a limited SyncML client 3330, while other information is communicated directly to phone's SyncML proxy 3312. Multimedia information can be provided via the support applications 3310 and 3330, while more basic information is provided to proxy 3312. An address book proxy 3120 splits information between the database 2718 and address book 3150.

In FIG. 34, the client is equivalent to FIG. 33 except that information is stored in the robust native address book 3010.

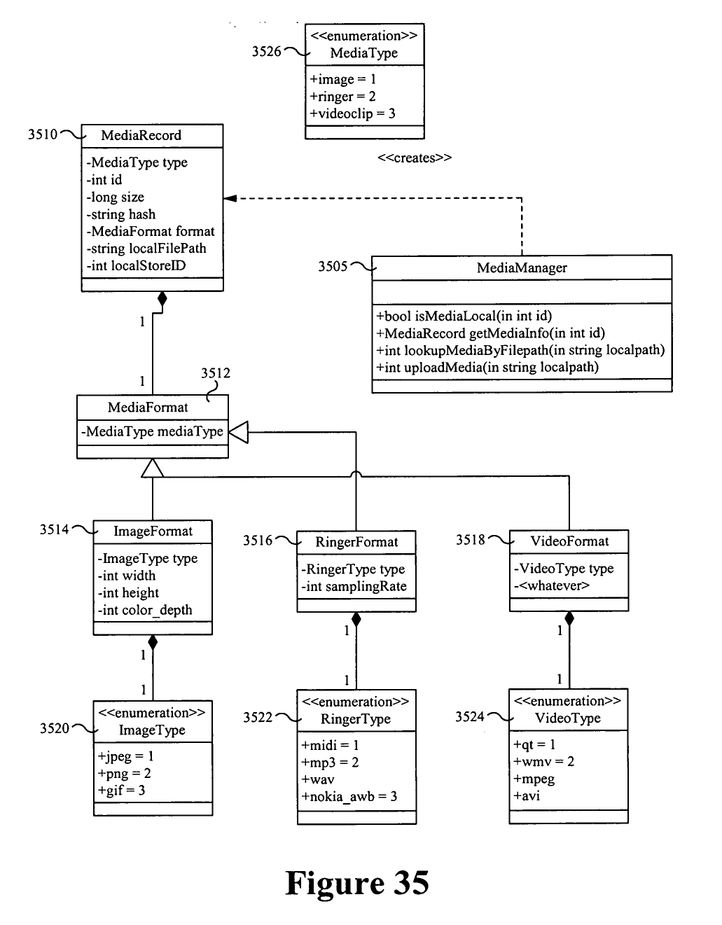

FIG. 35 illustrates a Media manager 3505 and the records associated with a piece of media information. The system supports digital rights media management. The MediaManger object provides an interface to the other client components which allows media uploading, media downloading, and retrieval of media information. Since each device has different capabilities, transcoding media objects from their original format is often required in order to support them on different devices. Transcoding refers to a process by which media in one format on one type of device or phone can be made available to other types of phones. For example, if a first user's phone creates pictures in JPEG format, but a receiving user's phone only supports GIF, the system server can automatically convert the format of the image based on the server's knowledge of the receiving user's phone. This same process may be used to change the resolution of an image to fit properly on the target device's display, given its characteristics.

Transcoding can involve an actual conversion or may involve simply selecting an alternative version of the media it already knows about. For example, a value added service provider may supply ringtones in two or more formats, and selection of the appropriate format can be made and distributed to the receiving user. When requesting media requires the media object, the transcoding will be performed by the server; the transcoded media will be transmitted to the device automatically. Clients may query information related to the media they are about to download using a function supplied in the communications protocol. This function will return relevant information concerning the transcoded media available to the client. The server may also provide transcode-on-demand support for clients which need multiple formats of the same media (e.g., image) in different sizes (e.g., a thumbnail for the contact in the address book and a full screen picture).

FIG. 35 illustrates the digital rights media record format utilized in the client application and present invention. Media manager 3505 determines whether or not the information in any media utilized in the device, whether a jpeg, mp3 movie, or the like, is a locally implemented piece of media or media from a value added provider. The media manager maintains records of the media location, whether it is downloadable or up-loadable and the like.

The system supports digital rights management contained in the native applications, allowing value added providers to check any media uploaded or downloaded to or from the server or client device to determine whether the information contained therein is subject to digitalized management. The media record 3510 which contains a media record type 3526 (local or not), identifier, size, hash value, a formula identifier, and a location. The media format 3512 can be any of an image format 3514, a ringer format 3516, a video format 3518. The image format type includes jpegs, pngs and gifs, as indicated at 3520. The ringtone format can be a midi-type, an mp3, a wav or a special awb format, as indicated at 3522. The video format can be an mpeg, wmv file, quicktime, or an avi, as indicated at 3524. Additional formats for images, ringers, and videoclips may be easily added without requiring significant system modification.

Monetization of an Advanced Contact Identification System

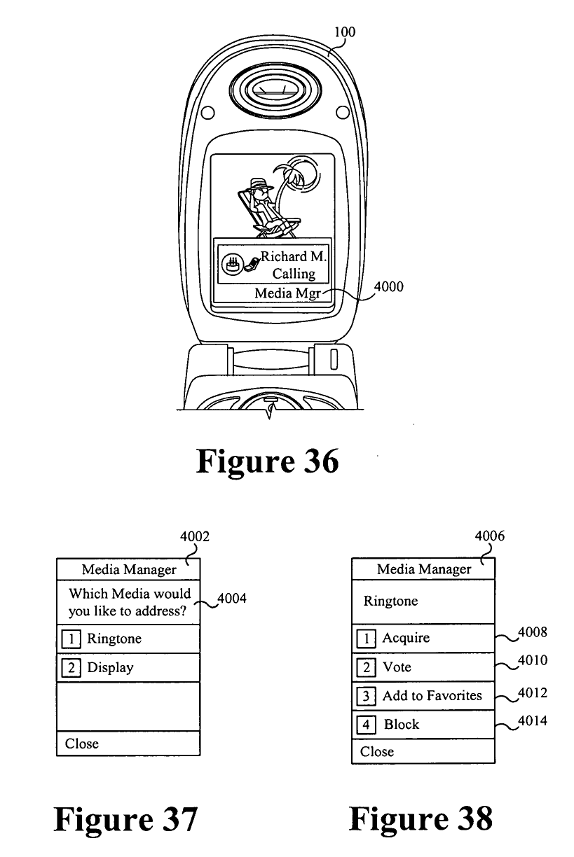

A system and method for monetizing the advanced contact identification system will now be described with reference to FIGS. 36-41. In particular, the wireless communication network including the advanced contact identification system as explained above is configurable to implement one or more methods aimed at increasing subscribership and revenues for the ESP and/or outside vendor, as well as driving sales of content.

In a first monetization embodiment, the advanced contact identification system as described above is configured to increase dissemination and sales of content. The system in this embodiment takes advantage of the fact that there is a higher likelihood that friends who associate with each other will have common interests, likes and dislikes. Therefore, in a scenario where caller A is friends with a number of call recipients, there is a higher likelihood that caller A's content will be of greater interest to the call recipients than other, non-targeted content that the call recipients encounter.

For example, caller A is the first in caller A's group to acquire a particular ringtone, image, video clip or other content which caller A has adopted as caller A's personal brand, to appear on the friends' phones upon contact by caller A. When caller A contacts one of caller A's friends, and caller A's personal brand content is presented over the friend's phones, the friend is presented with a user interface as shown in FIG. 36. The user interface is able to be initiated by accessing a “Media Mgr.” soft-key 4000 as shown on FIG. 36. The user is provided with the “Media Mgr.” soft-key 4000 upon an initial contact, a call, an SMS, an MMS or other type of contact session by caller A, during the contact session and/or after the contact session is completed. The “Media Mgr.” soft-key 4000 is in addition to the above-described soft-key enabled menu functions that are also displayed on the phone 100. For example, the “Media Mgr.” soft-key 4000 is displayed before, during and/or after the above-described menu functions. Alternatively, the “Media Mgr.” soft-key 4000 may be indicated by a variety of other words, graphics and/or icons.

Upon accessing the “Media Mgr.” soft-key 4000 using the device hard-keys, the user is presented with a user interface 4002, for example, including a media menu 4004 as shown in FIG. 37. In some embodiments, the media menu 4004 presents the user with different media types, e.g., ringtone or display. As shown in FIG. 38, once the user specifies a media type, the user is provided with an options menu 4006 with respect to caller A's content. Under the options menu 4006 for the ringtone media type, the user is presented with an acquire option 4008 allowing the user to acquire the caller media. The user is also presented with a vote option 4010 allowing the user to vote on the received content. The user is also presented with an add to favorites option 4012 to add the received content to a favorites list. The user is also presented with a block option 4014 to block the received content in the future. And, other options are possible.

Upon selection of the acquire option 4008 to acquire the media, once the contact session is completed, the user is guided through steps via prompts presented on the phone user interface to connect the user to a source of the media. In some embodiments, that source is the ESP. In other embodiments, the source is other networked locations. The user is then guided through the steps of purchasing the selected media. Alternatively, the purchasing steps are skipped if the media is free. The user is able to set the selected media as the user's own personal brand as explained above, distribute the selected media to others (under a limited or unlimited distribution license), or use the media as desired.

Using this system, a personal brand having popular ringtone, graphic or other content is be widely shared among friends and others within a social network. As explained hereinafter, the caller or content author, license-holder, or other party also or alternatively receives some sort of payment, credit or other incentive when the caller's media is purchased or acquired by others. Providing a monetization scheme for subscribers to share popular or incentivized content drives sales and/or distribution of such content. It also boosts revenue for the ESP and/or telecommunication operators in that the increase in the download of content also increases connection minutes, or bandwidth, or data volume consumed. In some embodiments, it also boosts subscribership for the ESP.

Upon selection of the vote option 4010 to vote on the media, upon completion of the contact session, the user is presented with additional menu screens allowing the user to give the user's opinion of the caller's media. The opinion may be quantitative, e.g., a numerical evaluation on a scale of for example 1 through 10, or qualitative, e.g., the user may enter a textual, visual, or verbal evaluation voicing the user's satisfaction or dissatisfaction with the content. This quantitative or qualitative evaluation is sent to the caller and/or uploaded to the ESP (or other) server for storage, where it is made available to the caller, and/or those with the appropriate permissions set by the caller. In another embodiment, the user is able to respond with media as a form of opining.

Upon selection of the add to favorites option 4012 to add the media to the favorites list, an identifier for the media is stored with the user's other designated favorites in the user's favorites list either locally on the phone 100 and/or within the advanced ID service server 160.

Upon selection of the block option 4014 to block the media, the media is blocked as described above. Preferably, the options 4008-4014 and the associated actions are managed, for example, by the client application 140. Any of the actions associated with the selected option 4008-4014 are stored locally on the phone 100 and/or synched to the advanced ID service server 160 where it may be stored.

In the above embodiments, upon setting a personal brand, the caller is able to announce the caller's presence when arriving at a social or other event by, for example, sending an SMS or an MMS message to one or more people at the event. Upon sending the message, the caller's personal brand appears and sounds out on a number of phones 100 simultaneously, in effect providing a chorus announcing the caller's arrival.

In embodiments of a monetization scheme described above with respect to FIGS. 36-38, media is acquired and distributed based on the popularity and attractiveness of the media. That is, a communication recipient is able to adopt the caller's content as the call recipient's own brand because the communication recipient likes the content. In a further embodiment of a monetization scheme, media is acquired and distributed based on incentives provided to users from advertisers. In such an embodiment, an advertiser makes available a desired advertisement embodied within a ringtone, a graphic and/or other media. In some embodiments, after enrolling with the ESP, the advertiser uploads the advertisement to the advanced ID service server 160, along with additional information relating to user incentives for adopting the advertisement as their personal brand ringtone and/or graphic, and, possibly additional information relating to the products or services offered by the advertiser.

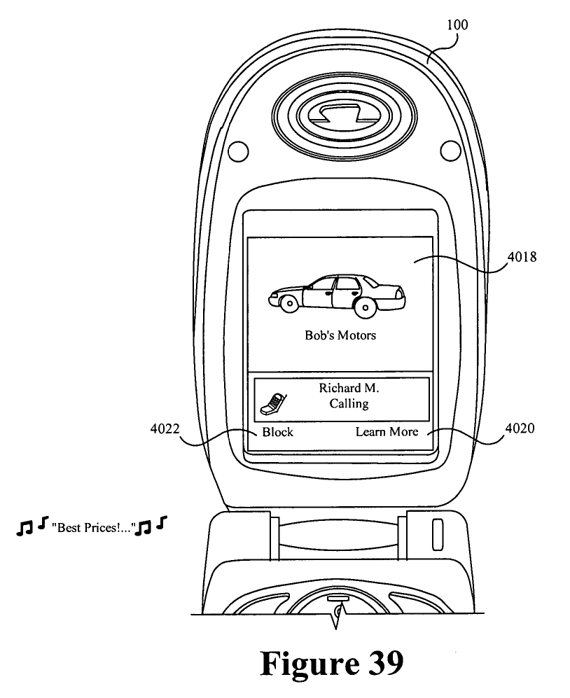

The advertisement and accompanying information are stored in the advanced ID service server 160, for example, in a database for such advertisements. A subscriber is able to access the advanced ID service server 160 and select an advertisement the subscriber is willing to use as the subscriber's brand. As shown in FIG. 39, once the subscriber adopts the advertisement as the subscriber's personal brand, when the subscriber places a call or initiates some other contact session, the call recipient will hear and/or see the advertisement on interface 4018, along with a learn more soft-key 4020 for the call recipient to learn more about the advertisement. The learn more soft-key 4020 is provided upon initiation of the contact session, during the contact session and/or upon completion of the contact session. A block soft-key 4022 is also provided for blocking this content as described above. Other soft-keys are possible too.

When the call recipient accesses the learn more soft-key 4020 to learn more information, the client application 140 couples the call recipient to the advanced ID service server 160. The client application 140 then controls the download of the stored additional information regarding the advertisement to the call recipient including any incentives for adopting the advertisement as the call recipient's personal brand. In alternative embodiments, the additional information regarding the advertisement downloads to the client phone 100 upon initiation of the contact session and is thereafter handled by the client application 140. The information regarding which advertisement the caller selected, which recipients were contacted by the caller after adopting the advertisement, and whether the recipient(s) accepted or blocked the advertisement are stored in the advanced ID service server 160. In some embodiments, both the caller and recipient(s) receive incentives in the form of payments and/or credits for sending/accepting the advertisement. In embodiments providing an incentive, the number of times an advertisement is sent/accepted to receive the incentive is limited. In other embodiments, the number of times is unlimited.

In the above-described model, the advertiser advertises indirectly, e.g., as a result of the caller adopting the advertisement as the caller's personal brand. In further embodiments, the advertiser advertises directly using the advanced contact identification system as explained above. In such an embodiment, the advertiser subscribes to the advanced contact identification system with an ESP as described above, sets an advertisement as the advertiser's brand, and then contacts recipients with the advertisement by making human initiated calls. Alternatively, an automatic dialer is used to contact the recipients. In a conventional telephone advertising model, the call recipient needs to answer a telephone call in order for the advertiser to convey the advertiser's content. The advertising model according to this embodiment allows the advertiser to convey the advertiser's content simply by initiating a call, an SMS message, an MMS message or other contact session. As described above, the recipient is provided with the ability to block receipt of this content.

Preferably, the recipient is given incentives by way of payments and/or credits for accepting the content. The recipient is provided with the learn more soft-key 4020 as shown in FIG. 39 to learn more about the advertisement. Upon accessing the learn more soft-key 4020, the recipient is then coupled by the client application 140 to the advanced ID service server 160 or directly to the advertiser's website. Such a model provides benefits, including the ability of the recipient to experience the content before deciding whether to actually acquire it in a “try before you buy” type model. The information regarding which recipients were contacted by the advertiser, and whether the recipient(s) accepted or blocked the advertisement, are typically stored in the advanced ID service server 160.

In a further monetization embodiment of the present invention, instead of acquiring media which is then set as the subscriber's personal brand, the subscriber generates the subscriber's own media as the subscriber's personal brand and has that as the subscriber's identification when making calls or initiating other contact sessions. The subscriber sets up the subscriber's personal brand via the user interface provided on phone 100. Alternatively, the subscriber interacts with a web browser user interface for the advanced ID service server 160 via a device other than phone 100 to set up and store the subscriber's personal brand. Once authored, the personal brand is then stored on the advanced ID service server 160 as described above.

The personal brand authored as described in the preceding paragraph may be either for personal or commercial advertising purposes. An authored brand for commercial advertising purposes has been described above. One benefit to such an advertising model is the speed with which the advertiser's content may be distributed. For example, where the advertiser offers an attractive incentive to those who adopt the advertiser's advertisement as their personal brand for dissemination to others, who then adopt and disseminate the brand, the advertiser's message is propagated at an exponential rate. Instead of providing an incentive to adopt/distribute, an individual or group is able to author a personal brand for commercial purposes and set a price for the adoption of their content by others. The individual or group is also able to charge a price for some or all downstream distribution and adoption, as well as receive and give incentives for all such downstream activity.

In further embodiments, vendors are able to associate with an ESP for providing the service of generating template or customized personal brands. In such embodiments, a vendor contacts the ESP via the user interface from a phone 100 or other device, and sets up one or more templates including various personal brands with different themes. These personal brands are stored on the advanced ID service server 160, where they are selected, for a fee or otherwise, by subscribers. Alternatively, subscribers and vendors connect through the ESP for a vendor to create a customized personal brand for the subscriber. Once the brand is created, the brand is stored on the advanced ID service server 160, and then selected by the subscriber as described above. In some embodiments, a personal brand extends beyond the context of a phone 100, for example to clothing and other accessories.

As indicated above, all of the information regarding which subscriber acquires or authors what content, which recipients have that content come up as the caller's identification, and which recipients accept, block, or comment on that content is tracked and stored within the advanced ID service server 160. Moreover, once a recipient acquires content as the recipient's personal brand, subject to rules set regarding distribution of that content, the acquirer then becomes a distributor of that content. The advanced ID service server 160 tracks and stores all downstream acquisition/distribution of content. This information is also used to generate an address book, based on personalized branding. That is, the address book is organized within the advanced ID service server 160 and synched to a phone 100, showing contacts which are organized by personal brands. The address book also shows a link between all persons within a given social network that acquired the same content and/or distributed content to each other.

Subscribers have the ability to connect to the advanced ID service server 160 as described above and review this information. Subscribers are able to tell whether their personal brand was popular by reviewing who else adopted their personal brand as their own and/or by reviewing the ratings tallied with the voting option (option 4010, FIG. 38) for their personal brand.

The information regarding the adoption/distribution of content stored on the advanced ID service server 160 is also used to make payments and fulfill incentives to subscribers in accordance with the conditions associated with adoption/distribution of such content. For example, if a condition for the adoption of content as a personal brand indicates that all those that adopt the content will receive a free coupon, and then an additional coupon for every additional ten subscribers they get to adopt the content, the distribution of the coupons are tracked and stored in the advanced ID service server 160. An advertiser is able to access the advanced ID service server 160 to determine how many coupons to distribute, and to whom, in accordance with that information.

Moreover, the stored information provides valuable demographic data to the ESP or vendor working with the ESP. For example, the stored information is able to indicate that content adopted as a personal brand and distributed by a particular subscriber is purchased at a higher rate than for the same content upon distribution by other subscribers. This would lead to a conclusion that this subscriber was more influential than others and that content distributed by him or her was more likely to lead to adoption by others and increased sale of a given content. The content owner is able to identify such a correlation from the information stored on the advanced ID service server 160, and is able to give added incentives to such influential subscribers. In particular, advertisers are able to send notification of a targeted advertisement to the influential subscribers offering them incentives to adopt the advertiser's content as their personal brand.

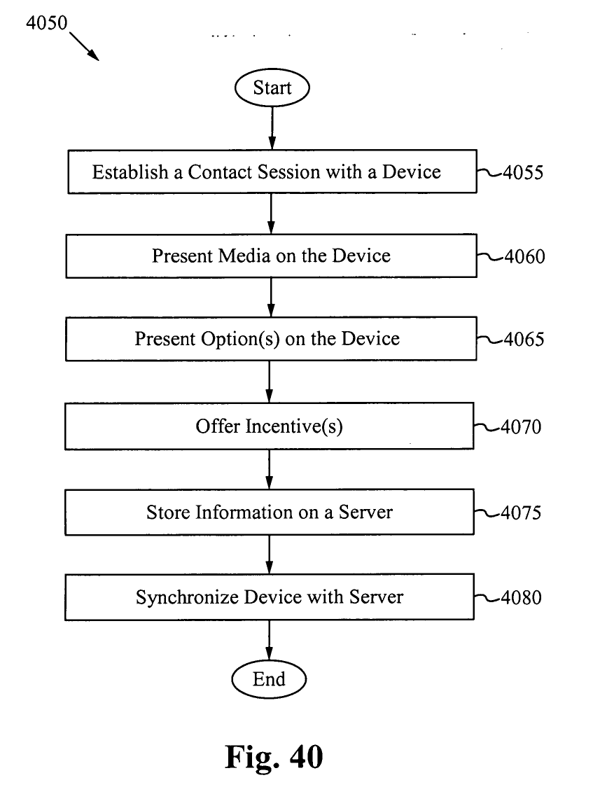

FIG. 40 illustrates a first process 4050 of monetizating the contact identification system. At the step 4055, a contact session in a network to a recipient is established. Typically, the network is a wireless communication network including the advanced contact identification system. As discussed above, the contact session is a call, an SMS message, an MMS message, an email, a voice clip, a reminder or other type of contact session, initiated by a caller. Preferably, the caller has previously adopted a media as the caller's personal brand. As such, the caller's media is presented on a device used by the recipient at the step 4060. Typically, the media is a ringtone, an image, a video clip, a music clip, and/or a song. The media is generated by an advertiser, a subscriber, and/or a vendor. At the step 4065, the recipient is presented with a plurality of options. As discussed above, the plurality of options include acquiring, giving an opinion of, adding, learning more about, or blocking the media. At the step 4070, at least one incentive is provided by an at least one entity. Preferably, the network is accessible by the at least one entity. Typically, the at least one entity is an ESP. Alternatively, the at least one entity is an advertiser. Preferably, the at least one incentive is offered. Typically, the at least one incentive is offered to the caller and/or the recipient. In some embodiments, the at least one incentive is credits, money, media, voucher, and/or coupon. At the step 4075, information, including the media and associated actions by the recipient, is stored on a server. The server is preferably a server in the network. At step 4080, the device and the server are synchronized.

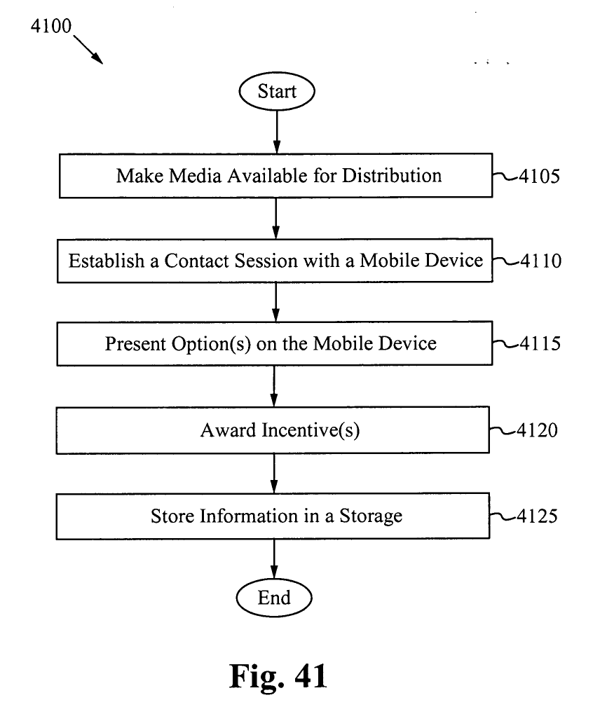

FIG. 41 illustrates a second process 4100 of monetizing the contact identification system. At the step 4105, media is made available for distribution in a network. Typically, the media is generated by an advertiser, a subscriber, and/or a vendor. At the step 4110, a contact session in the network with a mobile device is established. Preferably, the contact session is configured to present the media on the mobile device. As mentioned above, the media is a ringtone, an image, and/or a video clip. In some embodiments, the contact session is a human-initiated contact. In other embodiments, the contact session is an automatically-dialed contact. At the step 4115, a plurality of options are presented on the mobile device. As discussed above, the plurality of options include acquiring, giving an opinion of, adding, learning more about, or blocking the media. At the step 4120, an at least one entity with access to the network awards an at least one incentive. Preferably, the at least one incentive is awarded upon the recipient using the media in a predetermined manner. In some embodiments, the predetermined manner is purchasing the media. In other embodiments, the predetermined manner is distributing the media. Yet in other embodiments, the predetermined manner is acquiring, viewing, or distributing the media. At the step 4125, information, including the media and associated actions by the recipient, is stored in a storage. Typically, the storage is a network server or a database.

The present invention has been described in terms of specific embodiments incorporating details to facilitate the understanding of principles of construction and operation of the invention. Such reference herein to specific embodiments and details thereof is not intended to limit the scope of the claims appended hereto. A person skilled in the art would appreciate that various modifications and revisions to the monetization of the advanced contact identification system will occur. Consequently, the claims should be broadly construed, consistent with the spirit and scope of the invention, and should not be limited to their exact, literal meaning.

We claim:

1. A method of monetizing a contact identification system, the method comprising:
a. establishing a contact session in a network with a recipient;
b. presenting a media on a device used by the recipient; and
c. offering an at least one incentive by an at least one entity, wherein the network is accessible by the at least one entity.

2. The method of claim 1, wherein the contact session is selected from the group consisting of a call, an SMS message, an MMS message, an email, a voice clip, and a reminder.

3. The method of claim 1, wherein the media is selected from at least one of a ringtone, an image, a video clip, a music clip, and a song.

4. The method of claim 1, wherein the media is generated by at least one of an advertiser, a subscriber, and a vendor.

5. The method of claim 1, wherein the at least one incentive is offered upon the recipient using the media in a predetermined manner.

6. The method of claim 1, wherein the at least one incentive is offered to at least one of a caller and the recipient.

7. The method of claim 1, wherein the at least one incentive is at least one of credits, money, media, a voucher, and a coupon.

8. The method of claim 1, further comprising presenting the recipient with a plurality of options on the device.

9. The method of claim 8, wherein the plurality of options include at least one of acquiring, giving an opinion of, adding, learning more about and blocking the media.

10. The method of claim 1, further comprising storing information on a server, wherein the information includes the media and associated actions by the recipient.

11. The method of claim 1, further comprising synching the device with the server.

12. A monetization method for a contact identification system, the method comprising:
a. making available a media for distribution in a network;
b. establishing a contact session in the network with a mobile device, the contact session configured to present the media on the mobile device;
c. presenting a plurality of options for a user of the mobile device; and
d. awarding an at least one incentive by an at least one entity with access to the network, the at least one incentive awarded upon the recipient using the media in predetermined manner.

13. The method of claim 12, wherein the media is selected from the group consisting a ringtone, an image, and a video clip.

14. The method of claim 12, wherein the media is generated by at least one of an advertiser, a subscriber, and a vendor.

15. The method of claim 12, wherein the contact session is selected form the group consisting of a human-initiated contact and an automatically-dialed contact.

16. The method of claim 12, wherein the plurality of options include at least one of acquiring, giving an opinion of, adding, learning more about and blocking the media.

17. The method of claim 12, further comprising storing information in a storage, wherein the information includes the media and associated actions by the recipient, and wherein the storage is at least one of a network server and a database.

18. A system for monetization, the system comprising:
a. a device configured for accepting a contact session in a network, wherein the device is used by a recipient;
b. a media configured to render on the device; and
c. at least one entity with access to the network offering at least one incentive.

19. The system of claim 18, wherein the contact session is selected from the group consisting of a human-initiated contact and an automatically-initiated contact.

20. The system of claim 18, wherein the media is selected from the group consisting of a ringtone, an image, and a video clip.

21. The system of claim 18, wherein the at least one incentive is offered upon the recipient using the media in a predetermined manner.

22. The system of claim 18, further comprising a plurality of options on the device presented to the recipient.

23. The system of claim 22, wherein the plurality of options include at least one of acquiring, giving an opinion of, adding, learning more about and blocking the media.

24. The system of claim 18, further comprising at least one participant, wherein the at least one participant generates the media, the at least one participant is selected from the group consisting of an advertiser, a subscriber, and a vendor.

25. The system of claim 18, further comprising a server configured to store information, wherein the information includes the media and associated actions by the recipient.
